(19) United States
(12) Patent Application Publication
(10) Pub. No.: US 2026/0179571 A1
(43) Pub. Date: Jun. 25, 2026

(54) DISPLAY DEVICE INCLUDING DUMMY SUBPIXEL

(71) Applicant: LG Display Co., Ltd., Seoul (KR)

(72) Inventors: Yong-Won LEE, Paju-si (KR); Je-Kyoung LEE, Paju-si (KR)

(21) Appl. No.: 19/337,199

(22) Filed: Sep. 23, 2025

(30) Foreign Application Priority Data
Dec. 19, 2024 (KR) 10-2024-0190710

(51) Int. Cl. G09G 3/3275; G09G 3/00; G09G 3/3266

(52) U.S. Cl. CPC G09G 3/3275; G09G 3/006; G09G 3/3266; G09G 2300/0413; G09G 2300/0842; G09G 2310/08; G09G 2330/021; G09G 2330/08; G09G 2330/12

(57) ABSTRACT

A display device includes: a timing controlling unit generating image data, a data control signal and a gate control signal; a data driving unit generating a data signal using the image data and the data control signal; a gate driving unit generating a gate signal using the gate control signal; and a display panel displaying an image using the gate signal and the data signal, the display panel comprising a display area and a non-display area at a periphery of the display area, wherein: the display area comprises subpixels arranged as horizontal pixel lines, the non-display area comprises dummy subpixels, repair lines extend to the horizontal pixel lines, respectively, each dummy subpixel is connected to at least two repair lines extending to at least two horizontal pixel lines.

### CROSS-REFERENCE TO RELATED APPLICATION

Pursuant to 35 U.S.C. § 119(a), this application claims the benefit of an earlier filing date and right of priority to Korean Patent Application No. 10-2024-0190710 filed in the Republic of Korea on Dec. 19, 2024, the entire contents of which are hereby expressly incorporated by reference into the present application.

### TECHNICAL FIELD

The present disclosure relates to a display device.

### BACKGROUND

Recently, various flat panel display devices such as a liquid crystal display device (LCD), an organic light emitting diode (OLED) display device and a field emission display (FED) device having excellent properties of a thin profile, a light weight and a low power consumption have been developed and applied to various fields.

Among the various flat panel display devices, an organic light emitting diode (OLED) display device is an emissive type device that does not include a backlight unit used in a non-emissive type device such as a liquid crystal display (LCD) device. As a result, the OLED display device has advantages in a viewing angle, a contrast ratio and a power consumption to be applied to various fields.

### SUMMARY

According to one aspect, a display device includes: a timing controlling unit configured to generate image data, a data control signal and a gate control signal; a data driving unit configured to generate a data signal using the image data and the data control signal; a gate driving unit configured to generate a gate signal using the gate control signal; and a display panel configured to display an image using the gate signal and the data signal, the display panel comprising a display area and a non-display area at a periphery of the display area, wherein: the display area comprises a plurality of subpixels arranged as a plurality of horizontal pixel lines, the non-display area comprises a plurality of dummy subpixels, a plurality of repair lines extend to the plurality of horizontal pixel lines, respectively, and each of the plurality of dummy subpixels is connected to at least two of the plurality of repair lines extending to at least two of the plurality of horizontal pixel lines.

### BRIEF DESCRIPTION OF THE DRAWINGS

The accompanying drawings, which are included to provide a further understanding of the disclosure and are incorporated in and constitute a part of this specification, illustrate implementations of the disclosure and together with the description serve to explain the principles of the disclosure.

FIG. 1 is a view showing a display device according to a first implementation of the present disclosure;

FIG. 2 is a circuit diagram showing a subpixel of a display device according to a first implementation of the present disclosure;

FIG. 3 is a circuit diagram showing a dummy subpixel of a display device according to a first implementation of the present disclosure;

FIG. 4 is a view showing a plurality of signals of a subpixel and a dummy subpixel of a display device according to a first implementation of the present disclosure;

FIG. 5 is a view showing a dummy subpixel and a subpixel of a display device according to a first implementation of the present disclosure;

FIG. 6A is a view showing a first connection state of a dummy subpixel and an abnormal subpixel of a display device according to a first implementation of the present disclosure;

FIG. 6B is a view showing data signals of a first connection state of a dummy subpixel and an abnormal subpixel of a display device according to a first implementation of the present disclosure;

FIG. 7A is a view showing a second connection state of a dummy subpixel and an abnormal subpixel of a display device according to a first implementation of the present disclosure;

FIG. 7B is a view showing data signals of a second connection state of a dummy subpixel and an abnormal subpixel of a display device according to a first implementation of the present disclosure;

FIG. 8A is a view showing a third connection state of a dummy subpixel and an abnormal subpixel of a display device according to a first implementation of the present disclosure;

FIG. 8B is a view showing data signals of a third connection state of a dummy subpixel and an abnormal subpixel of a display device according to a first implementation of the present disclosure;

FIG. 9 is a view showing a dummy subpixel and a subpixel of a display device according to a second implementation of the present disclosure;

FIG. 10A is a view showing a first connection state of a dummy subpixel and an abnormal subpixel of a display device according to a second implementation of the present disclosure;

FIG. 10B is a view showing data signals and emission2 signals of a second connection state of a dummy subpixel and an abnormal subpixel of a display device according to a second implementation of the present disclosure;

FIG. 11A is a view showing a second connection state of a dummy subpixel and an abnormal subpixel of a display device according to a second implementation of the present disclosure;

FIG. 11B is a view showing data signals and emission2 signals of a second connection state of a dummy subpixel and an abnormal subpixel of a display device according to a second implementation of the present disclosure;

FIG. 12A is a view showing a third connection state of a dummy subpixel and an abnormal subpixel of a display device according to a second implementation of the present disclosure; and

FIG. 12B is a view showing data signals and emission2 signals of a third connection state of a dummy subpixel and an abnormal subpixel of a display device according to a second implementation of the present disclosure.

### DETAILED DESCRIPTION

When a plurality of transistors and a capacitor of a subpixel of an OLED display device abnormally operate, a light emitting diode of the subpixel can emit a light of a luminance greater or smaller than a target luminance. This can cause a deterioration, such as a bright dot or a dark dot, to occur.

To improve such a deterioration of a subpixel, a diode voltage can be generated using a plurality of transistors and a capacitor of a dummy subpixel, and the diode voltage can be supplied to the light emitting diode of the subpixel having the deterioration to emit a light of a normal luminance. However, the diode voltage can be reduced according to a position of the abnormal subpixel (e.g., due to a voltage drop (IR drop) by a parasitic resistance and a parasitic capacitance of a repair line transmitting the diode voltage), which can cause the light emitting diode to emit a light of a luminance different from the target luminance and can deteriorate a display quality of an image.

Accordingly, implementations of the present disclosure are directed to a display device that substantially obviates one or more of the problems due to limitations and disadvantages of the related art.

Implementations of the present disclosure can provide a display device where a deterioration such as a bright dot or a dark dot is prevented and a display quality is improved by a plurality of dummy subpixels

It is to be understood that both the foregoing general description and the following detailed description are examples and explanatory and are intended to provide further explanation of the inventive concepts as claimed.

Additional features and advantages of the disclosure will be set forth in the description which follows, and in part will be apparent from the description, or can be learned by practice of the disclosure. These and other advantages of the disclosure will be realized and attained by the structure particularly pointed out in the written description and claims hereof as well as the appended drawings.

Advantages and features of the present disclosure, and implementation methods thereof will be clarified through following example aspects described with reference to the accompanying drawings. The present disclosure can, however, be implemented in different forms and should not be construed as limited to the example aspects set forth herein. Rather, these example aspects are provided so that this disclosure will be sufficiently thorough and complete so as to assist those skilled in the art to fully understand the scope of the present disclosure.

The shapes, sizes, ratios, angles, numbers, and the like, which are illustrated in the drawings to describe various example aspects of the present disclosure, are merely given by way of example. Therefore, the present disclosure is not limited to the illustrations in the drawings. Like reference numerals refer to like elements throughout the specification, unless otherwise specified.

In the following description, where the detailed description of the relevant known function or configuration may unnecessarily obscure a feature or aspect of the present disclosure, a detailed description of such known function or configuration may be omitted or a brief description may be provided.

Where the terms “comprise,” “have,” “include,” and the like are used, one or more other elements can be added unless the term, such as “only,” is used. An element described in the singular form is intended to include a plurality of elements, and vice versa, unless the context clearly indicates otherwise.

In construing an element, the element is to be construed as including an error or a tolerance range even where no explicit description of such an error or tolerance range is provided.

Where positional relationships are described, for example, where the positional relationship between two parts is described using “on,” “over,” “under,” “above,” “below,” “beside,” “next,” or the like, one or more other parts can be located between the two parts unless a more limiting term, such as “immediate(ly),” “direct(ly),” or “close(ly)” is used. For example, where an element or layer is disposed “on” another element or layer, a third layer or element can be interposed therebetween.

Although the terms “first,” “second,” A, B, (a), (b), and the like may be used herein to refer to various elements, these elements should not be interpreted to be limited by these terms as they are not used to define a particular order or precedence. These terms are only used to distinguish one element from another. For example, a first element could be termed a second element, and, similarly, a second element could be termed a first element, without departing from the scope of the present disclosure.

The term “at least one” should be understood to include all combinations of one or more of related elements. For example, the term of “at least one of first, second and third elements” can include all combinations of two or more of the first, second and third elements as well as the first, second or third element.

The term “display device” can include a display device in a narrow sense such as liquid crystal module (LCM), an organic light emitting diode (OLED) module and a quantum dot (QD) module including a display panel and a driving unit for driving the display panel. In addition, the term “display device” can include a complete product (or a final product) including the LCM, the OLED module and the QD module such as a notebook computer, a television, a computer monitor, an equipment display device including an automotive display apparatus or a shape other than a vehicle, and a set electronic apparatus or a set device (or a set apparatus) such as a mobile electronic apparatus of a smart phone or an electronic pad.

Accordingly, a display device of the present disclosure can include an applied product or a set device of a final user's device including the LCM, the OLED module and the QD module as well as a display device in a narrow sense such as the LCM, the OLED module and the QD module.

According to circumstances, the LCM, the OLED module and the QD module having a display panel and a driving unit can be expressed as “a display device”, and an electronic apparatus of a complete product including the LCM, the OLED module and the QD module can be expressed as “a set device.” For example, a display device in a narrow sense can include a display panel of a liquid crystal, an organic light emitting diode and a quantum dot and a source printed circuit board (PCB) of a control unit for driving the display panel, and a set device can further include a set PCB of a set control unit electrically connected to the source PCB for controlling the entire set device.

The display panel of the present disclosure can include all kinds of display panels such as a liquid crystal display panel, an organic light emitting diode display panel, a quantum dot display panel and an electroluminescent display panel. The display panel of the present disclosure is not limited to a specific display panel of a bezel bending having a flexible substrate for an organic light emitting diode display panel and a lower back plate supporter. A shape or a size of the display panel for the display device of the present disclosure is not limited thereto.

For example, when the display panel is an organic light emitting diode display panel, the display panel can include a plurality of gate lines, a plurality of data lines and a subpixel in a crossing region of the plurality of gate lines and the plurality of data lines. The display panel can include an array having a thin film transistor of an element for selectively applying a voltage to each subpixel, an emitting element layer on the array and an encapsulating substrate or an encapsulation part covering the emitting element layer. The encapsulation part can protect the thin film transistor and the emitting element layer from an external impact and can prevent or at least reduce penetration of a moisture or oxygen into the emitting element layer. In addition, the emitting element layer on the array can include an inorganic light emitting layer, for example, a nano-sized material layer or a quantum dot.

The thin film transistor of the present disclosure can include one of an oxide thin film transistor, an amorphous silicon thin film transistor, and a low temperature polycrystalline silicon thin film transistor.

Features of various implementations of the present disclosure can be partially or entirely coupled to or combined with each other. They can be linked and operated technically in various ways as those skilled in the art will sufficiently understand. The aspects can be carried out independently of or in association with each other in various combinations.

Hereinafter, a display device according to various example implementations of the present disclosure where an influence on an oxide semiconductor layer of a thin film transistor of a driving element part is reduced by shielding a light emitted and transmitted from a subpixel and/or a light inputted from an exterior will be described in detail with reference to the accompanying drawings.

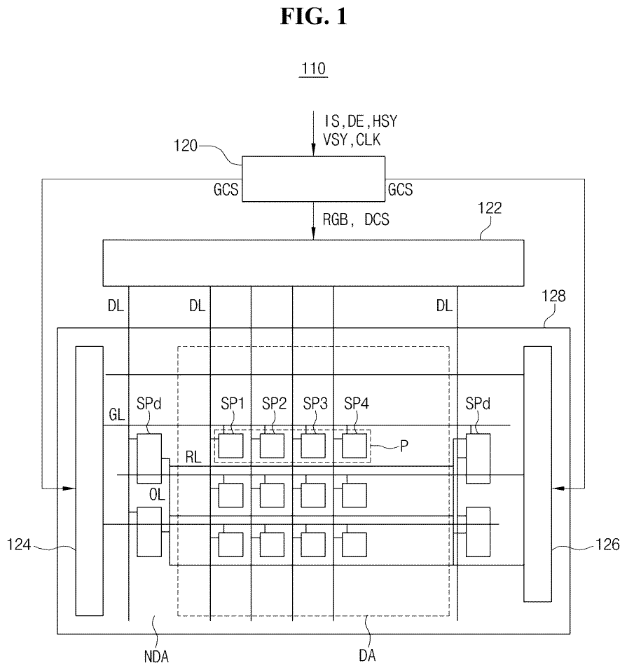

FIG. 1 is a view showing a display device according to a first implementation of the present disclosure. Although the display device can be an organic light emitting diode (OLED) display device, it is not limited thereto. For example, the display device can be a quantum dot display device, a micro light emitting diode (LED) display device or a mini light emitting diode (LED) display device.

In FIG. 1, a display device 110 according to a first implementation of the present disclosure includes a timing controlling unit 120 (e.g., a circuit), a data driving unit 122 (e.g., a circuit), first and second gate driving units 124 and 126 (e.g., circuits) and a display panel 128.

The timing controlling unit 120 generates an image data RGB, a data control signal DCS and a gate control signal GCS using an image signal IS and a plurality of timing signals including a data enable signal DE, a horizontal synchronization signal HSY, a vertical synchronization signal VSY and a clock signal CLK transmitted from an external system such as a graphic card or a television system.

The timing controlling unit 120 transmits the image data RGB and the data control signal DCS to the data driving unit 122 and transmits the gate control signal GCS to the first and second gate driving units 124 and 126.

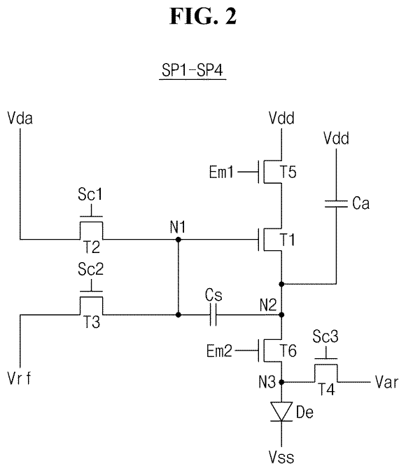

The data driving unit 122 generates a data signal (data voltage) Vda (of FIG. 2) using the image data RGB and the data control signal DCS transmitted from the timing controlling unit 120 and applies the data signal Vda to a data line DL of the display panel 128.

The first and second gate driving units 124 and 126 generate a gate signal (gate voltage) Sc1, Sc2, Sc3, Em1 and Em2 (of FIG. 2) using the gate control signal GCS transmitted from the timing controlling unit 120 and applies the gate signal Sc1, Sc2, Sc3, Em1 and Em2 to a gate line GL of the display panel 128.

The first and second gate driving units 124 and 126 can have a gate in panel (GIP) type to be formed in a non-display area NDA of a substrate of the display panel 128 having the gate line GL, the data line DL and a pixel P.

Although the first and second gate driving units 124 and 126 are disposed in both side portions of the display panel 128 in the first implementation of FIG. 1, one gate driving unit can be disposed in one side portion of the display panel 128 in another implementation.

The display panel 128 includes a display area DA at a central portion thereof and a non-display area NDA surrounding the display area DA. The display panel 128 displays an image using the gate signal Sc1, Sc2, Sc3, Em1 and Em2 and the data signal Vda. For displaying an image, the display panel 128 includes a plurality of pixels P, a plurality of gate lines GL and a plurality of data lines DL in the display area DA.

Each of the plurality of pixels P includes first to fourth subpixels SP1 to SP4. The gate line GL and the data line DL cross each other to define the first to fourth subpixels SP1 to SP4, and each of the first to fourth subpixels SP1 to SP4 is connected to the gate line GL and the data line DL.

For example, the first to fourth subpixels SP1 to SP4 can correspond to red, green, blue and white colors, respectively.

Although one pixel P exemplarily includes the first to fourth subpixels SP1 to SP4 in the first implementation of FIG. 1, one pixel P can include first, second and third subpixels SP1, SP2 and SP3 corresponding to red, green and blue colors, respectively, in another implementation.

The first to fourth subpixels SP1 to SP4 are disposed in a matrix shape to be classified into a plurality of horizontal pixel lines and a plurality of vertical pixel lines.

When the display device 110 is an organic light emitting diode (OLED) display device, each of the first to fourth subpixels SP1 to SP4 can include a plurality of transistors T1 to T6 (of FIG. 2) such as a switching transistor, a driving transistor and a sensing transistor, a storage capacitor Cs (of FIG. 2), an auxiliary capacitor Ca (of FIG. 2) and a light emitting diode De (of FIG. 2).

To supply a diode voltage to the light emitting diode De of a subpixel SP1 to SP4 where the plurality of transistors and the plurality of capacitors abnormally function, the display panel 128 includes a plurality of dummy subpixels SPd, an output line OL and a plurality of repair lines RL disposed at both side portions of the non-display area NDA.

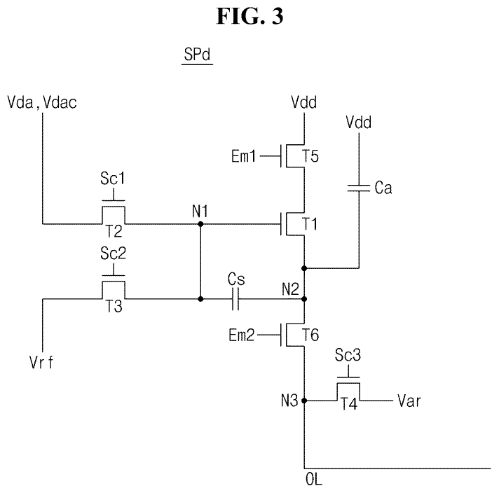

Each of the plurality of dummy subpixels SPd includes the plurality of transistors T1 to T6 (of FIG. 3) and the plurality of capacitors Cs and Ca (of FIG. 3).

Each of the plurality of dummy subpixels SPd is connected to the output line OL, and the output line OL is connected to the repair line RL parallel to and spaced apart from the plurality of gate lines GL.

The repair line RL (or an extending line of the repair line RL) can overlap an anode (or a connecting line of the anode) of the light emitting diode of the plurality of subpixels in one horizontal pixel line.

The plurality of output lines OL connected to the plurality of dummy subpixels SPd are connected to the plurality of repair lines RL. A number of the plurality of output lines OL can be smaller than a number of the plurality of repair lines RL.

For example, two output lines OL connected to two dummy subpixels SPd can be connected to three repair lines RL corresponding to three horizontal pixel lines.

A structure of the subpixel SP1 to SP4 and the dummy subpixel SPd of the display device 110 will be illustrated with reference to drawings.

FIG. 2 is a circuit diagram showing a subpixel of a display device according to a first implementation of the present disclosure, and FIG. 3 is a circuit diagram showing a dummy subpixel of a display device according to a first implementation of the present disclosure.

In FIG. 2, each of the first to fourth subpixels SP1 to SP4 of the display panel 128 of the display device 110 according to a first implementation of the present disclosure includes first to sixth transistors T1 to T6, a storage capacitor Cs, an auxiliary capacitor Ca and a light emitting diode De.

Although the first to sixth transistors T1 to T6 have a negative type in the first implementation of FIG. 2, at least one of the first to sixth transistors T1 to T6 can have a positive type in another implementation.

The first transistor T1 as a driving transistor is switched according to a voltage of a first node N1. A gate electrode of the first transistor T1 is connected to the first node N1, a source electrode of the first transistor T1 is connected to a second node N2, and a drain electrode of the first transistor T1 is connected to a source electrode of the fifth transistor T5.

The second transistor T2 as a switching transistor is switched according to a scan1 signal Sc1. A gate electrode of the second transistor T2 is connected to the scan1 signal Sc1, a source electrode of the second transistor T2 is connected to the first node N1, a drain electrode of the second transistor T2 is connected to a data signal Vda.

The third transistor T3 as a reference transistor is switched according to a scan2 signal Sc2. A gate electrode of the third transistor T3 is connected to the scan2 signal Sc2, a source electrode of the third transistor T3 is connected to the first node N1, and a drain electrode of the third transistor T3 is connected to a reference signal Vrf.

The fourth transistor T4 as a reset transistor is switched according to a scan3 signal Sc3. A gate electrode of the fourth transistor T4 is connected to the scan3 signal Sc3, a source electrode of the fourth transistor T4 is connected to a third node N3, and a drain electrode of the fourth transistor T4 is connected to an anode reset signal Var.

The fifth transistor T5 as an emitting transistor is switched according to an emission1 signal Em1. A gate electrode of the fifth transistor T5 is connected to the emission1 signal Em1, a source electrode of the fifth transistor T5 is connected to the drain electrode of the first transistor T1, and a drain electrode of the fifth transistor T5 is connected to a high level signal Vdd.

The sixth transistor T6 as an emitting transistor is switched according to an emission2 signal Em2. A gate electrode of the sixth transistor T6 is connected to the emission2 signal Em2, a source electrode of the sixth transistor T6 is connected to the third node N3, and a drain electrode of the sixth transistor T6 is connected to the second node N2.

The storage capacitor Cs stores the data signal Vda and a threshold voltage (Vth) of the first transistor T1. A first capacitor electrode of the storage capacitor Cs is connected to the first node N1, and a second capacitor electrode of the storage capacitor Cs is connected to the second node N2.

The auxiliary capacitor Ca determines a voltage of the first node N1 according to a ratio thereof with respect to the storage capacitor Cs. A first capacitor electrode of the auxiliary capacitor Ca is connected to the second node N2, and a second capacitor electrode of the auxiliary capacitor Ca is connected to the high level signal Vdd.

The light emitting diode De is connected between the third node N3 and a low level signal (low level voltage) Vss and emits a light of a luminance proportional to a current of the first transistor T1. An anode of the light emitting diode De is connected to the third node N3, and a cathode of the light emitting diode De is connected to the low level signal Vss.

The gate electrode of the first transistor T1, the first capacitor electrode of the storage capacitor Cs, the source electrode of the second transistor T2 and the source electrode of the third transistor T3 constitute the first node N1, and the source electrode of the first transistor T1 and the second capacitor electrode of the storage capacitor Cs constitute the second node N2. The source electrode of the fourth transistor T4, the source electrode of the sixth transistor T6 and the anode of the light emitting diode De constitute the third node N3.

Although each of the first to fourth subpixels SP1 to SP4 has a 6T2C structure having six transistors and two capacitors in the first implementation of FIG. 2, one subpixel can have one of a 3T1C structure having three transistors and one capacitor, a 7T1C structure having seven transistors and one capacitor, a 7T2C structure having seven transistors and two capacitors and a 8T1C structure having eight transistors and one capacitor in another implementation.

Further, the auxiliary capacitor Ca can be omitted in another implementation.

In FIG. 3, the dummy subpixel SPd of the display panel 128 of the display device 110 according to a first implementation of the present disclosure includes first to sixth transistors T1 to T6, a storage capacitor Cs and an auxiliary capacitor Ca.

Although the first to sixth transistors T1 to T6 have a negative type in the first implementation of FIG. 2, at least one of the first to sixth transistors T1 to T6 can have a positive type in another implementation.

Since a connection structure of the first to sixth transistors T1 to T6, the storage capacitor Cs and the auxiliary capacitor Ca of the dummy subpixel SPd is the same as that of the first to sixth transistors T1 to T6, the storage capacitor Cs and the auxiliary capacitor Ca of each of the first to fourth subpixels SP1 to SP4 except that the third node N3 is connected to the output line OL, illustration on the connection structure of the dummy subpixel SPd can be omitted.

The gate electrode of the first transistor T1, the first capacitor electrode of the storage capacitor Cs, the source electrode of the second transistor T2 and the source electrode of the third transistor T3 constitute the first node N1, and the source electrode of the first transistor T1, the second capacitor electrode of the storage capacitor Cs, the first capacitor electrode of the auxiliary capacitor Ca and the drain electrode of the sixth transistor T6 constitute the second node N2. The source electrode of the fourth transistor T4 and the source electrode of the sixth transistor T6 constitute the third node N3.

An operation of the first to fourth subpixels SP1 to SP4 and the dummy subpixel SPd will be illustrated with reference to a drawing.

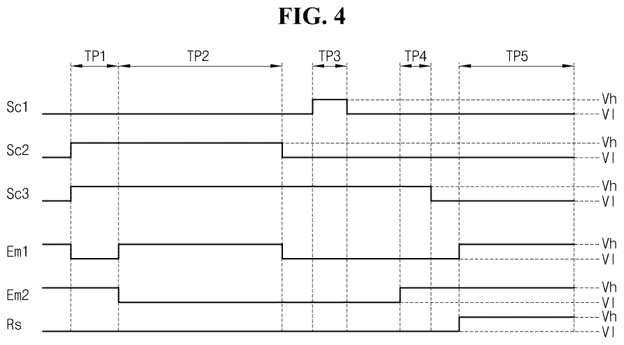

FIG. 4 is a view showing a plurality of signals of a subpixel and a dummy subpixel of a display device according to a first implementation of the present disclosure.

In FIG. 4, the display device 110 according to a first implementation of the present disclosure is driven through an initializing period, a sensing period, a writing period, an anode reset period and an emitting period.

During a first period TP1 as the initializing period, the third, fourth and sixth transistors T3, T4 and T6 are turned on due to a scan2 signal Sc2, a scan3 signal Sc3 and an emission2 signal Em2 of a logic high voltage Vh, and the second and fifth transistors T2 and T5 are turned off due to a scan1 signal Sc1, an emision1 signal Em1 and a repair sensing signal Rs of a logic low voltage Vl. The reference signal Vrf is applied to the first node N1, and the anode reset signal Var is applied to the third and second nodes N3 and N2. As a result, the first capacitor electrode of the storage capacitor Cs and the gate electrode of the first transistor T1 are initialized by the reference signal Vrf, and the second capacitor electrode of the storage capacitor Cs and the anode of the light emitting diode De are initialized by the anode reset signal Var.

During a second period TP2 as the sensing period, the third, fourth and fifth transistors T3, T4 and T5 are turned on due to the scan2 signal Sc2, the scan3 signal Sc3 and the emission1 signal Em1 of a logic high voltage Vh, and the second and sixth transistor T2 and T6 are turned off due to the scan1 signal Sc1, the emission2 signal Em2 and the repair sensing signal Rs of a logic low voltage Vl. The reference signal Vrf is applied to the first node N1, and the anode reset signal Var is applied to the third node N3. Since the first transistor T1 is turned on and the high level signal Vdd is applied to the second node N2, the second capacitor electrode of the storage capacitor Cs becomes a value (Vrf−Vth) obtained by subtracting the threshold voltage (Vth) from the reference signal Vrf. As a result, the threshold voltage Vth is stored in the storage capacitor Cs, and the anode of the light emitting diode De is kept as the anode reset signal Var.

During a third period TP3 as the writing period, the second and fourth transistors T2 and T4 are turned on due to the scan1 signal Sc1 and the sccan3 signal Sc3 of a logic high voltage Vh, and the third, fifth and sixth transistors T3, T5 and T6 are turned off due to the scan2 signal Sc2, the emission1 signal Em1, the emission2 signal Em2 and the repair sensing signal Rs of a logic low voltage Vl. The data signal Vda is applied to the first node N1, and the anode reset signal Var is applied to the third node N3. As a result, the first capacitor electrode of the storage capacitor Cs and the gate electrode of the first transistor T1 become the data signal Vda, and the second capacitor electrode of the storage capacitor Cs becomes a sum (Vrf−Vth+α(Vda−Vrf)) of a difference (Vrf−Vth) of the reference signal Vrf and the threshold voltage (Vth) and a value obtained by multiplying a capacitor ratio α to a difference (Vda−Vrf) of the data signal Vda and the reference signal Vrf. Accordingly, the threshold voltage (Vth) and the data signal Vda are stored in the storage capacitor Cs, and the anode of the light emitting diode De is kept as the anode reset signal Var.

The capacitor ratio α is defined as a ratio (Cs/(Cs+Ca)) of the storage capacitor Cs with respect to a sum (Cs+Ca) of the storage capacitor Cs and the auxiliary capacitor Ca, and a value obtained by subtracting a voltage of the second node N2 from a voltage of the first node N1 (a gate-source voltage (Vgs) of the first transistor T1 as a driving transistor) becomes ‘(1−α)(Vda−Vrf)+Vth.’

During a fourth period TP4 as the anode reset period, the fourth and sixth transistors T4 and T6 are turned on due to the scan3 signal Sc3 and the emission2 signal Em2 of a logic high voltage Vh, and the second, third and fifth transistors T2, T3 and T5 are turned off due to the scan1 signal Sc1, the scan2 signal Sc2, the emission1 signal Em1 and the repair sensing signal Rs of a logic low voltage V1. As a result, the anode reset signal Var is applied to the third and second nodes N3 and N2, and the anode of the light emitting diode De is reset by the anode reset signal Var.

During a fifth period TP5 as the emitting period, the fifth and sixth transistors T5 and T6 are turned on due to the emission1 signal Em1, the emission2 signal Em2 and the repair sensing signal Rs of a logic high voltage Vh, and the second, third and fourth transistors T2, T3 and T4 are turned off due to the scan1 signal Sc1, the scan2 signal Sc2 and the scan3 signal Sc3 of a logic low voltage Vl. The first transistor T1 is turned on, and the high level voltage Vdd is applied to the drain electrode of the first transistor T1. As a result, a current proportional to a square of a value (Vgs−Vth=(1−α)(Vda−Vrf)+Vth−Vth=(1−α) (Vda−Vrf)) obtained by subtracting the threshold voltage (Vth) from a gate-source voltage (Vgs=(1−α)(Vda−Vrf)+Vth) flows through the first transistor T1, and the light emitting diode De emits a light of a luminance corresponding to the current flowing through the first transistor T1.

The voltage (i.e., diode voltage) of the third node N3 of the dummy subpixel SPd is transmitted to the anode of the light emitting diode De of the abnormal subpixel among the plurality of subpixels in the horizontal pixel line through the output line OL and the repair line RL. In the display device 110 according to a first implementation of the present disclosure, since two dummy subpixels SPd are disposed to correspond to three horizontal pixel lines, an area assigned to each dummy subpixel SPd increases to increase an area of the auxiliary capacitor Ca.

As a result, since the current of the first transistor T1 sufficiently increases due to decrease of the capacitor ratio α, the voltage drop of the repair line RL due to the parasitic resistance and the parasitic capacitance can be compensated.

A connection structure of the dummy subpixel SPd and the subpixel SP1 to SP4 will be illustrated with reference to a drawing.

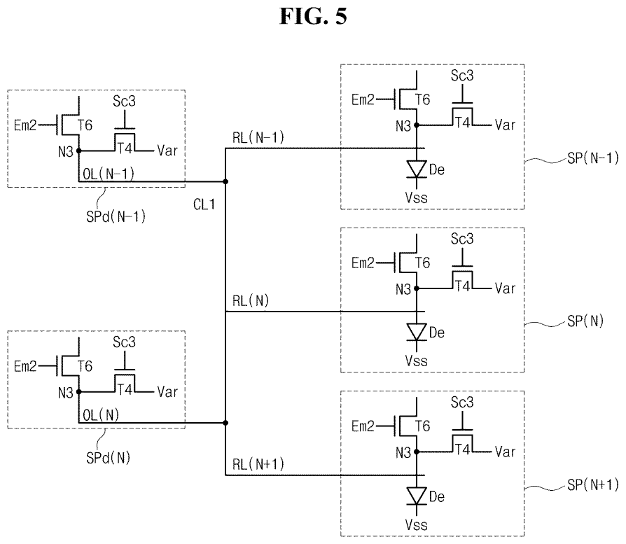

FIG. 5 is a view showing a dummy subpixel and a subpixel of a display device according to a first implementation of the present disclosure. For illustration's convenience, only the fourth and sixth transistors T4 and T6 of the dummy subpixel SPd, the fourth and sixth transistors T4 and T6 and the light emitting diode De of the subpixel SP1 to SP4 are shown in FIG. 5.

In FIG. 5, two dummy subpixels SPd are disposed to correspond to three horizontal pixel lines.

For example, adjacent (N−1)th and (N)th dummy subpixels SPd(N−1) and SPd(N) are disposed to correspond to adjacent (N−1)th, (N)th and (N+1)th horizontal pixel lines, and the (N−1)th, (N)th and (N+1)th horizontal pixel lines include (N−1)th, (N)th and (N+1)th subpixels SP(N−1), SP(N) and SP(N+1), respectively.

An (N−1)th output line OL(N−1) of the (N−1)th dummy subpixel SPd(N−1) is connected to a first connecting line CL1 connecting (N−1)th, (N)th and (N+1)th repair lines RL(N−1), RL(N) and RL(N+1). The (N−1)th repair line RL(N−1) (or an extending line of the (N−1)th repair line RL(N−1)) overlaps an anode (or a connecting line of the anode) of the light emitting diode De of each (e.g., the (N−1)th subpixel SP(N−1)) of the plurality of subpixels in the (N−1)th horizontal pixel line, the (N)th repair line RL(N) (or an extending line of the (N)th repair line RL(N)) overlaps an anode (or a connecting line of the anode) of the light emitting diode De of each (e.g., the (N)th subpixel SP(N)) of the plurality of subpixels in the (N)th horizontal pixel line, and (N+1)th repair line RL(N+1) (or an extending line of the (N+1)th repair line RL(N+1)) overlaps an anode (or a connecting line of the anode) of the light emitting diode De of each (e.g., the (N+1)th subpixel SP(N+1)) of the plurality of subpixels in the (N+1)th horizontal pixel line.

A repair process due to the dummy subpixel SPd will be illustrated with reference to drawings.

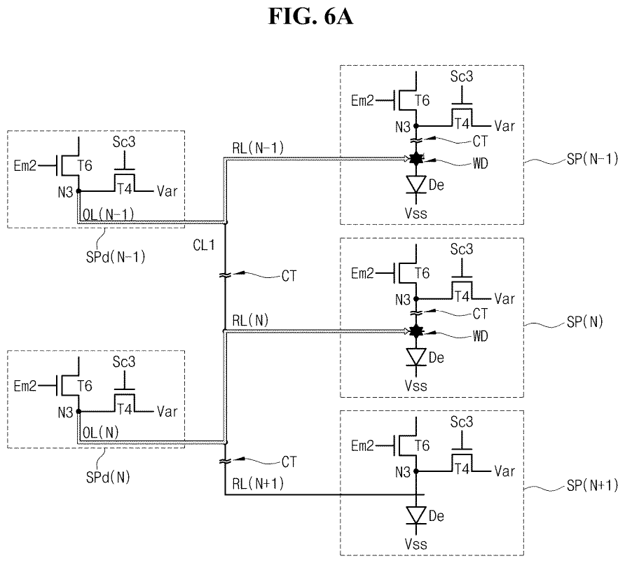

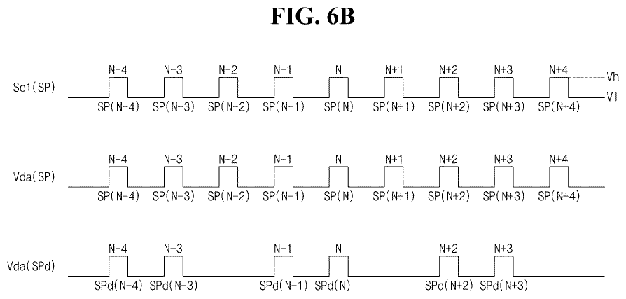

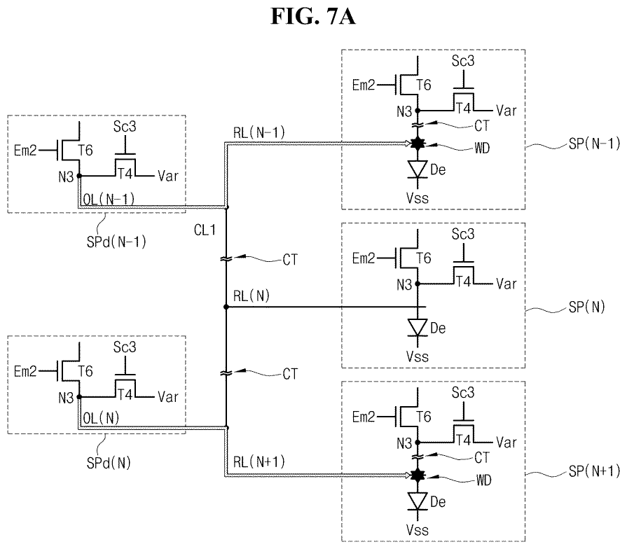

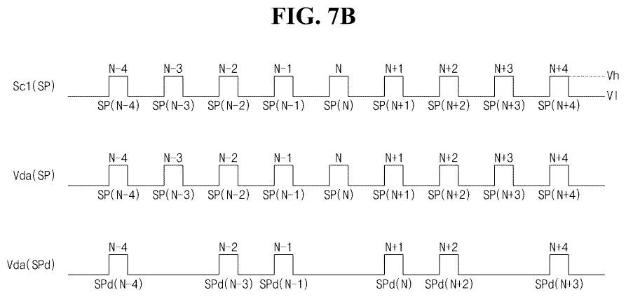

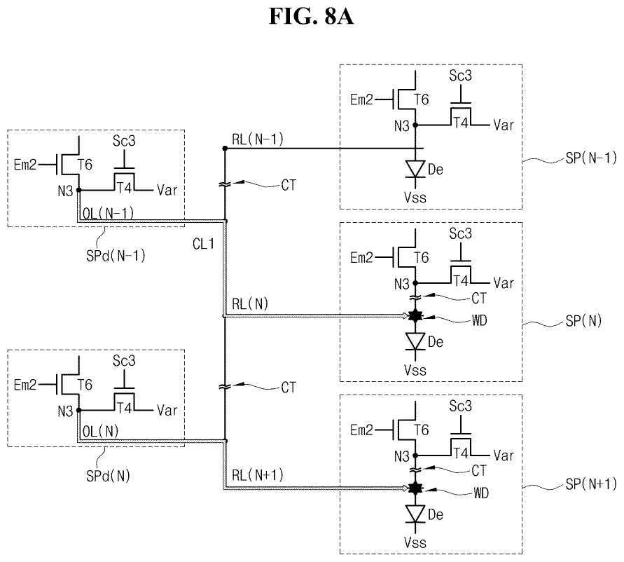

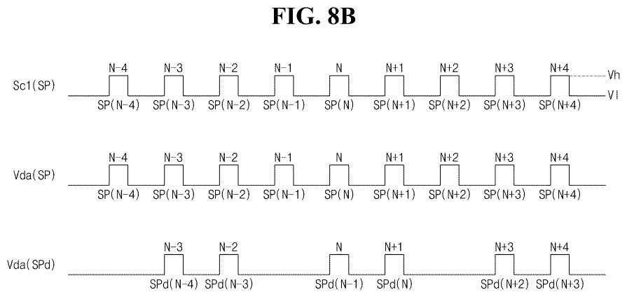

FIG. 6A is a view showing a first connection state of a dummy subpixel and an abnormal subpixel of a display device according to a first implementation of the present disclosure, and FIG. 6B is a view showing data signals of a first connection state of a dummy subpixel and an abnormal subpixel of a display device according to a first implementation of the present disclosure. FIG. 7A is a view showing a second connection state of a dummy subpixel and an abnormal subpixel of a display device according to a first implementation of the present disclosure, and FIG. 7B is a view showing data signals of a second connection state of a dummy subpixel and an abnormal subpixel of a display device according to a first implementation of the present disclosure. FIG. 8A is a view showing a third connection state of a dummy subpixel and an abnormal subpixel of a display device according to a first implementation of the present disclosure, and FIG. 8B is a view showing data signals of a third connection state of a dummy subpixel and an abnormal subpixel of a display device according to a first implementation of the present disclosure.

In FIG. 6A, for a first connection state where the first to sixth transistors T1 to T6, the storage capacitor Cs and the auxiliary capacitor Ca of the (N−1)th and (N)th subpixels SP(N−1) and SP(N) of the (N−1)th and (N)th horizontal pixel lines abnormally operate, a connection of the third node N3 and the light emitting diode De of the (N−1)th subpixel SP(N−1) is cut, and a connection of the third node N3 and the light emitting diode De of the (N)th subpixel SP(N) is cut. Further, the light emitting diode De of the (N−1)th subpixel SP(N−1) and the (N−1)th repair line RL(N−1) are connected to each other, and the light emitting diode De of the (N)th subpixel SP(N) and the (N)th repair line RL(N) are connected to each other.

For example, a connecting line connecting the third node N3 and the anode of the light emitting diode De can be cut (CT) in the (N−1)th subpixel SP(N−1), and a connecting line connecting the third node N3 and the anode of the light emitting diode De can be cut (CT) in the (N)th subpixel SP(N). Further, the connecting line of the anode of the light emitting diode De of the (N−1)th subpixel SP(N−1) and the (N−1)th repair line RL(N−1) can be connected (welded) (WD) to each other, and the connecting line of the anode of the light emitting diode De of the (N)th subpixel SP(N) and the (N)th repair line RL(N) can be connected (welded) (WD) to each other.

The (N−1)th and (N)th repair lines RL(N−1) and RL(N) and the connecting lines of the anodes of the light emitting diodes De of the (N−1)th and (N)th subpixels SP(N−1) and SP(N) can overlap each other with an insulating layer interposed therebetween, and the insulating layer can be broken through a welding process (WD) to electrically connect the (N−1)th and (N)th repair lines RL(N−1) and RL(N) and the connecting lines of the anodes of the light emitting diodes De of the (N−1)th and (N)th subpixels SP(N−1) and SP(N).

In addition, a connection of the (N−1)th output line OL(N−1) of the (N−1)th dummy subpixel SPd(N−1) and the (N)th repair line RL(N) is cut, and a connection of the (N)th output line OL(N) of the (N)th dummy subpixel SPd(N) and the (N+1)th repair line RL(N+1) is cut.

For example, a first connecting line CL1 connecting the (N−1)th output line OL(N−1) of the (N−1)th dummy subpixel SPd(N−1) and the (N)th repair line RL(N) can be cut (CT), and a first connecting line CL1 connecting the (N)th output line OL(N) of the (N)th dummy subpixel SPd(N) and the (N+1)th repair line RL(N+1) can be cut (CT).

As a result, in the first connection state, the third node N3 of the (N−1)th dummy subpixel SPd(N−1) is connected to and supplies the diode voltage to the anode of the light emitting diode De of the (N−1)th subpixel SP(N−1), and the third node N3 of the (N)th dummy subpixel SPd(N) is connected to and supplies the diode voltage to the anode of the light emitting diode De of the (N)th subpixel SP(N). Accordingly, the light emitting diodes De of the (N−1)th and (N)th subpixels SP(N−1) and SP(N) emit a light of a normal luminance.

The data signals Vda corresponding to the (N−1)th and (N)th horizontal pixel lines are supplied to the (N−1)th and (N)th dummy subpixels SPd(N−1) and SPd(N), respectively.

In FIG. 6B, for the first connection state, during a period where a logic high voltage Vh of the scan1 signal Sc1 is applied to the gate electrodes of the second transistors T2 of (N−4)th, (N−3)th, (N−2)th, (N−1)th, (N)th, (N+1)th, (N+2)th, (N+3)th and (N+4)th subpixels SP(N−4), SP(N−3), SP(N−2), SP(N−1), SP(N), SP(N+1), SP(N+2), SP(N+3) and SP(N+4) of (N−4)th, (N−3)th, (N−2)th, (N−1)th, (N)th, (N+1)th, (N+2)th, (N+3)th and (N+4)th horizontal pixel lines, (N−4)th, (N−3)th, (N−2)th, (N−1)th, (N)th, (N+1)th, (N+2)th, (N+3)th and (N+4)th data signals Vda(N−4), Vda(N−3), Vda(N−2), Vda(N−1), Vda(N), Vda(N+1), Vda(N+2), Vda(N+3) and Vda(N+4) are applied to the drain electrodes of the second transistors T2 of the (N−4)th, (N−3)th, (N−2)th, (N−1)th, (N)th, (N+1)th, (N+2)th, (N+3)th and (N+4)th subpixels SP(N−4), SP(N−3), SP(N−2), SP(N−1), SP(N), SP(N+1), SP(N+2), SP(N+3) and SP(N+4), respectively.

During a period where a logic high voltage Vh of the scan1 signal Sc1 is applied to the gate electrodes of the second transistors T2 of (N−4)th, (N−3)th, (N−1)th, (N)th, (N+2)th and (N+3)th subpixels SP(N−4), SP(N−3), SP(N−1), SP(N), SP(N+2) and SP(N+3), a logic high voltage Vh of the scan1 signal Sc1 is applied to the gate electrodes of the second transistors T2 of the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3), respectively, and the (N−4)th, (N−3)th, (N−1)th, (N)th, (N+2)th and (N+3)th data signals Vda(N−4), Vda(N−3), Vda(N−1), Vda(N), Vda(N+2) and Vda(N+3) are applied to the drain electrodes of the second transistors T2 of the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3), respectively.

In the first connection state, the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3) generate the diode voltages using the (N−4)th, (N−3)th, (N−1)th, (N)th, (N+2)th and (N+3)th data signals Vda(N−4), Vda(N−3), Vda(N−1), Vda(N), Vda(N+2) and Vda(N+3), respectively, and supply the diode voltages to the anodes of the light emitting diodes De of the (N−4)th, (N−3)th, (N−1)th, (N)th, (N+2)th and (N+3)th subpixels SP(N−4), SP(N−3), SP(N−1), SP(N), SP(N+2) and SP(N+3), respectively.

In FIG. 7A, for a second connection state where the first to sixth transistors T1 to T6, the storage capacitor Cs and the auxiliary capacitor Ca of the (N−1)th and (N+1)th subpixels SP(N−1) and SP(N+1) of the (N−1)th and (N+1)th horizontal pixel lines abnormally operate, a connection of the third node N3 and the light emitting diode De of the (N−1)th subpixel SP(N−1) is cut, and a connection of the third node N3 and the light emitting diode De of the (N+1)th subpixel SP(N+1) is cut. Further, the light emitting diode De of the (N−1)th subpixel SP(N−1) and the (N−1)th repair line RL(N−1) are connected to each other, and the light emitting diode De of the (N+1)th subpixel SP(N+1) and the (N+1)th repair line RL(N+1) are connected to each other.

For example, a connecting line connecting the third node N3 and the anode of the light emitting diode De can be cut (CT) in the (N−1)th subpixel SP(N−1), and a connecting line connecting the third node N3 and the anode of the light emitting diode De can be cut (CT) in the (N+1)th subpixel SP(N+1). Further, the connecting line of the anode of the light emitting diode De of the (N−1)th subpixel SP(N−1) and the (N−1)th repair line RL(N−1) can be connected (welded) (WD) to each other, and the connecting line of the anode of the light emitting diode De of the (N+1)th subpixel SP(N+1) and the (N+1)th repair line RL(N+1) can be connected (welded) (WD) to each other.

The (N−1)th and (N+1)th repair lines RL(N−1) and RL(N+1) and the connecting lines of the anodes of the light emitting diodes De of the (N−1)th and (N+1)th subpixels SP(N−1) and SP(N+1) can overlap each other with an insulating layer interposed therebetween, and the insulating layer can be broken through a welding process (WD) to electrically connect the (N−1)th and (N+1)th repair lines RL(N−1) and RL(N+1) and the connecting lines of the anodes of the light emitting diodes De of the (N−1)th and (N+1)th subpixels SP(N−1) and SP(N+1).

In addition, a connection of the (N−1)th output line OL(N−1) of the (N−1)th dummy subpixel SPd(N−1) and the (N)th repair line RL(N) is cut, and a connection of the (N)th output line OL(N) of the (N)th dummy subpixel SPd(N) and the (N)th repair line RL(N) is cut.

For example, a first connecting line CL1 connecting the (N−1)th output line OL(N−1) of the (N−1)th dummy subpixel SPd(N−1) and the (N)th repair line RL(N) can be cut (CT), and a first connecting line CL1 connecting the (N)th output line OL(N) of the (N)th dummy subpixel SPd(N) and the (N)th repair line RL(N) can be cut (CT).

As a result, in the second connection state, the third node N3 of the (N−1)th dummy subpixel SPd(N−1) is connected to and supplies the diode voltage to the anode of the light emitting diode De of the (N−1)th subpixel SP(N−1), and the third node N3 of the (N)th dummy subpixel SPd(N) is connected to and supplies the diode voltage to the anode of the light emitting diode De of the (N+1)th subpixel SP(N+1). Accordingly, the light emitting diodes De of the (N−1)th and (N+1)th subpixels SP(N−1) and SP(N+1) emit a light of a normal luminance.

The data signals Vda corresponding to the (N−1)th and (N+1)th horizontal pixel lines are supplied to the (N−1)th and (N)th dummy subpixels SPd(N−1) and SPd(N), respectively.

In FIG. 7B, for the second connection state, during a period where a logic high voltage Vh of the scan1 signal Sc1 is applied to the gate electrodes of the second transistors T2 of (N−4)th, (N−3)th, (N−2)th, (N−1)th, (N)th, (N+1)th, (N+2)th, (N+3)th and (N+4)th subpixels SP(N−4), SP(N−3), SP(N−2), SP(N−1), SP(N), SP(N+1), SP(N+2), SP(N+3) and SP(N+4) of (N−4)th, (N−3)th, (N−2)th, (N−1)th, (N)th, (N+1)th, (N+2)th, (N+3)th and (N+4)th horizontal pixel lines, (N−4)th, (N−3)th, (N−2)th, (N−1)th, (N)th, (N+1)th, (N+2)th, (N+3)th and (N+4)th data signals Vda(N−4), Vda(N−3), Vda(N−2), Vda(N−1), Vda(N), Vda(N+1), Vda(N+2), Vda(N+3) and Vda(N+4) are applied to the drain electrodes of the second transistors T2 of the (N−4)th, (N−3)th, (N−2)th, (N−1)th, (N)th, (N+1)th, (N+2)th, (N+3)th and (N+4)th subpixels SP(N−4), SP(N−3), SP(N−2), SP(N−1), SP(N), SP(N+1), SP(N+2), SP(N+3) and SP(N+4), respectively.

During a period where a logic high voltage Vh of the scan1 signal Sc1 is applied to the gate electrodes of the second transistors T2 of (N−4)th, (N−2)th, (N−1)th, (N+1)th, (N+2)th and (N+4)th subpixels SP(N−4), SP(N−2), SP(N−1), SP(N+1), SP(N+2) and SP(N+4), a logic high voltage Vh of the scan1 signal Sc1 is applied to the gate electrodes of the second transistors T2 of the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3), respectively, and the (N−4)th, (N−2)th, (N−1)th, (N+1)th, (N+2)th and (N+4)th data signals Vda(N−4), Vda(N−2), Vda(N−1), Vda(N+1), Vda(N+2) and Vda(N+4) are applied to the drain electrodes of the second transistors T2 of the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3), respectively.

In the second connection state, the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3) generate the diode voltages using the (N−4)th, (N−2)th, (N−1)th, (N+1)th, (N+2)th and (N+4)th data signals Vda(N−4), Vda(N−2), Vda(N−1), Vda(N+1), Vda(N+2) and Vda(N+4), respectively, and supply the diode voltages to the anodes of the light emitting diodes De of the (N−4)th, (N−2)th, (N−1)th, (N+1)th, (N+2)th and (N+4)th subpixels SP(N−4), SP(N−2), SP(N−1), SP(N+1), SP(N+2) and SP(N+4), respectively.

In FIG. 8A, for a third connection state where the first to sixth transistors T1 to T6, the storage capacitor Cs and the auxiliary capacitor Ca of the (N)th and (N+1)th subpixels SP(N) and SP(N+1) of the (N)th and (N+1)th horizontal pixel lines abnormally operate, a connection of the third node N3 and the light emitting diode De of the (N)th subpixel SP(N) is cut, and a connection of the third node N3 and the light emitting diode De of the (N+1)th subpixel SP(N+1) is cut. Further, the light emitting diode De of the (N)th subpixel SP(N) and the (N)th repair line RL(N) are connected to each other, and the light emitting diode De of the (N+1)th subpixel SP(N+1) and the (N+1)th repair line RL(N+1) are connected to each other.

For example, a connecting line connecting the third node N3 and the anode of the light emitting diode De can be cut (CT) in the (N)th subpixel SP(N), and a connecting line connecting the third node N3 and the anode of the light emitting diode De can be cut (CT) in the (N+1)th subpixel SP(N+1). Further, the connecting line of the anode of the light emitting diode De of the (N)th subpixel SP(N) and the (N)th repair line RL(N) can be connected (welded) (WD) to each other, and the connecting line of the anode of the light emitting diode De of the (N+1)th subpixel SP(N+1) and the (N+1)th repair line RL(N+1) can be connected (welded) (WD) to each other.

The (N)th and (N+1)th repair lines RL(N) and RL(N+1) and the connecting lines of the anodes of the light emitting diodes De of the (N)th and (N+1)th subpixels SP(N) and SP(N+1) can overlap each other with an insulating layer interposed therebetween, and the insulating layer can be broken through a welding process (WD) to electrically connect the (N)th and (N+1)th repair lines RL(N) and RL(N+1) and the connecting lines of the anodes of the light emitting diodes De of the (N)th and (N+1)th subpixels SP(N) and SP(N+1).

In addition, a connection of the (N−1)th output line OL(N−1) of the (N−1)th dummy subpixel SPd(N−1) and the (N−1)th repair line RL(N−1) is cut, and a connection of the (N)th output line OL(N) of the (N)th dummy subpixel SPd(N) and the (N)th repair line RL(N) is cut.

For example, a first connecting line CL1 connecting the (N−1)th output line OL(N−1) of the (N−1)th dummy subpixel SPd(N−1) and the (N−1)th repair line RL(N−1) can be cut (CT), and a first connecting line CL1 connecting the (N)th output line OL(N) of the (N)th dummy subpixel SPd(N) and the (N)th repair line RL(N) can be cut (CT).

As a result, in the third connection state, the third node N3 of the (N−1)th dummy subpixel SPd(N−1) is connected to and supplies the diode voltage to the anode of the light emitting diode De of the (N)th subpixel SP(N), and the third node N3 of the (N)th dummy subpixel SPd(N) is connected to and supplies the diode voltage to the anode of the light emitting diode De of the (N+1)th subpixel SP(N+1). Accordingly, the light emitting diodes De of the (N)th and (N+1)th subpixels SP(N) and SP(N+1) emit a light of a normal luminance.

The data signals Vda corresponding to the (N)th and (N+1)th horizontal pixel lines are supplied to the (N−1)th and (N)th dummy subpixels SPd(N−1) and SPd(N), respectively.

In FIG. 8B, for the third connection state, during a period where a logic high voltage Vh of the scan1 signal Sc1 is applied to the gate electrodes of the second transistors T2 of (N−4)th, (N−3)th, (N−2)th, (N−1)th, (N)th, (N+1)th, (N+2)th, (N+3)th and (N+4)th subpixels SP(N−4), SP(N−3), SP(N−2), SP(N−1), SP(N), SP(N+1), SP(N+2), SP(N+3) and SP(N+4) of (N−4)th, (N−3)th, (N−2)th, (N−1)th, (N)th, (N+1)th, (N+2)th, (N+3)th and (N+4)th horizontal pixel lines, (N−4)th, (N−3)th, (N−2)th, (N−1)th, (N)th, (N+1)th, (N+2)th, (N+3)th and (N+4)th data signals Vda(N−4), Vda(N−3), Vda(N−2), Vda(N−1), Vda(N), Vda(N+1), Vda(N+2), Vda(N+3) and Vda(N+4) are applied to the drain electrodes of the second transistors T2 of the (N−4)th, (N−3)th, (N−2)th, (N−1)th, (N)th, (N+1)th, (N+2)th, (N+3)th and (N+4)th subpixels SP(N−4), SP(N−3), SP(N−2), SP(N−1), SP(N), SP(N+1), SP(N+2), SP(N+3) and SP(N+4), respectively.

During a period where a logic high voltage Vh of the scan1 signal Sc1 is applied to the gate electrodes of the second transistors T2 of (N−3)th, (N−2)th, (N)th, (N+1)th, (N+3)th and (N+4)th subpixels SP(N−3), SP(N−2), SP(N), SP(N+1), SP(N+3) and SP(N+4), a logic high voltage Vh of the scan1 signal Sc1 is applied to the gate electrodes of the second transistors T2 of the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3), respectively, and the (N−3)th, (N−2)th, (N)th, (N+1)th, (N+3)th and (N+4)th data signals Vda(N−3), Vda(N−2), Vda(N), Vda(N+1), Vda(N+3) and Vda(N+4) are applied to the drain electrodes of the second transistors T2 of the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3), respectively.

In the third connection state, the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3) generate the diode voltages using the (N−3)th, (N−2)th, (N)th, (N+1)th, (N+3)th and (N+4)th data signals Vda(N−3), Vda(N−2), Vda(N), Vda(N+1), Vda(N+3) and Vda(N+4), respectively, and supply the diode voltages to the anodes of the light emitting diodes De of the (N−3)th, (N−2)th, (N)th, (N+1)th, (N+3)th and (N+4)th subpixels SP(N−3), SP(N−2), SP(N), SP(N+1), SP(N+3) and SP(N+4), respectively.

In the display device 110 according to a first implementation of the present disclosure, the dummy subpixels SPd are formed to have a number smaller than a number of the horizontal pixel lines to increase an area of the auxiliary capacitor Ca of each dummy subpixel. As a result, the current of the first transistor T1 increases, and deterioration such as a bright dot or a dark dot is prevented by compensating the voltage drop through the repair line RL. Further, a display quality is improved and a low power consumption driving is obtained.

In another implementation, the emission2 signal of the dummy subpixel can be synchronized to the emission2 signal of the subpixel.

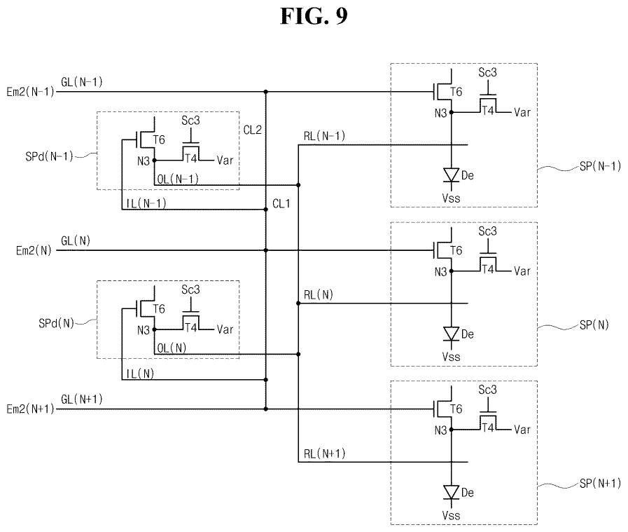

FIG. 9 is a view showing a dummy subpixel and a subpixel of a display device according to a second implementation of the present disclosure. Illustration on a part the same as that of the first implementation can be omitted. For illustration's convenience, only the fourth and sixth transistors T4 and T6 of the dummy subpixel SPd, the fourth and sixth transistors T4 and T6 and the light emitting diode De of the subpixel SP1 to SP4 are shown in FIG. 9.

In FIG. 9, a structure of a display device according to a second implementation of the present disclosure is the same as that of the display device 110 according to a first implementation of the present disclosure except that gate electrodes of sixth transistors T6 of two dummy subpixels SPd are connected to input lines IL and the input lines IL are connected to three gate lines GL transmitting the emission2 signal Em2.

Two dummy subpixels SPd are disposed to correspond to three horizontal pixel lines.

For example, adjacent (N−1)th and (N)th dummy subpixels SPd(N−1) and SPd(N) are disposed to correspond to adjacent (N−1)th, (N)th and (N+1)th horizontal pixel lines, and the (N−1)th, (N)th and (N+1)th horizontal pixel lines include (N−1)th, (N)th and (N+1)th subpixels SP(N−1), SP(N) and SP(N+1), respectively.

An (N−1)th output line OL(N−1) of the (N−1)th dummy subpixel SPd(N−1) is connected to a first connecting line CL1 connecting (N−1)th, (N)th and (N+1)th repair lines RL(N−1), RL(N) and RL(N+1). The (N−1)th repair line RL(N−1) (or an extending line of the (N−1)th repair line RL(N−1)) overlaps an anode (or a connecting line of the anode) of the light emitting diode De of each (e.g., the (N−1)th subpixel SP(N−1)) of the plurality of subpixels in the (N−1)th horizontal pixel line, the (N)th repair line RL(N) (or an extending line of the (N)th repair line RL(N)) overlaps an anode (or a connecting line of the anode) of the light emitting diode De of each (e.g., the (N)th subpixel SP(N)) of the plurality of subpixels in the (N)th horizontal pixel line, and (N+1)th repair line RL(N+1) (or an extending line of the (N+1)th repair line RL(N+1)) overlaps an anode (or a connecting line of the anode) of the light emitting diode De of each (e.g., the (N+1)th subpixel SP(N+1)) of the plurality of subpixels in the (N+1)th horizontal pixel line.

The gate electrodes of the sixth transistors T6 of the (N−1)th and (N)th dummy subpixels SPd(N−1) and SPd(N) are connected to (N−1)th and (N)th input lines IL(N−1) and IL(N), respectively, and the (N−1)th and (N)th input lines IL(N−1) and IL(N) of the (N−1)th and (N)th dummy subpixels SPd(N−1) and SPd(N) are connected to a second connecting line CL2 connecting (N−1)th, (N)th and (N+1)th gate lines GL(N−1), GL(N) and GL(N+1). The (N−1)th, (N)th and (N+1)th gate lines GL(N−1), GL(N) and GL(N+1) transmit (N−1)th, (N)th and (N+1)th emision2 signals Em2(N−1), Em2(N) and Em2(N+1), respectively.

A repair process due to the dummy subpixel SPd will be illustrated with reference to drawings.

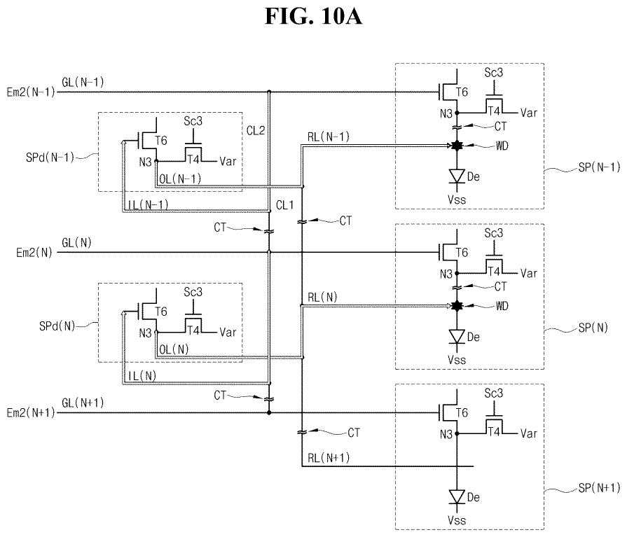

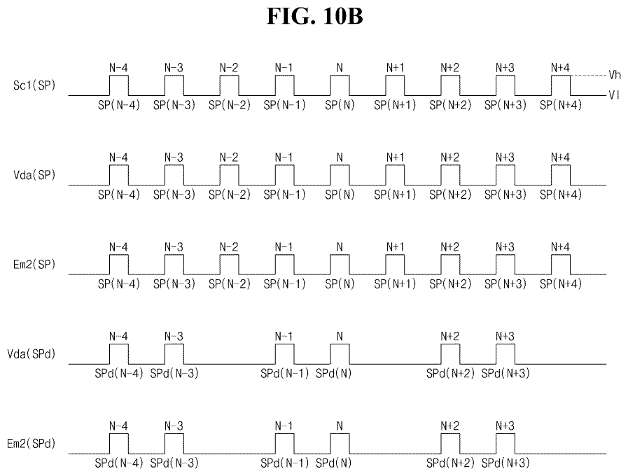

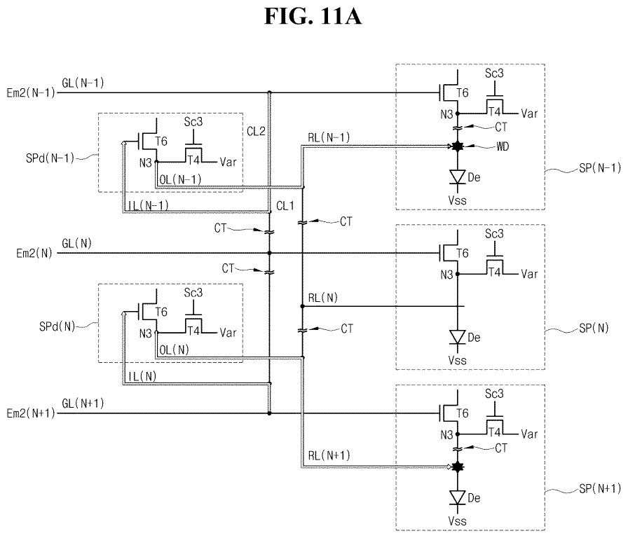

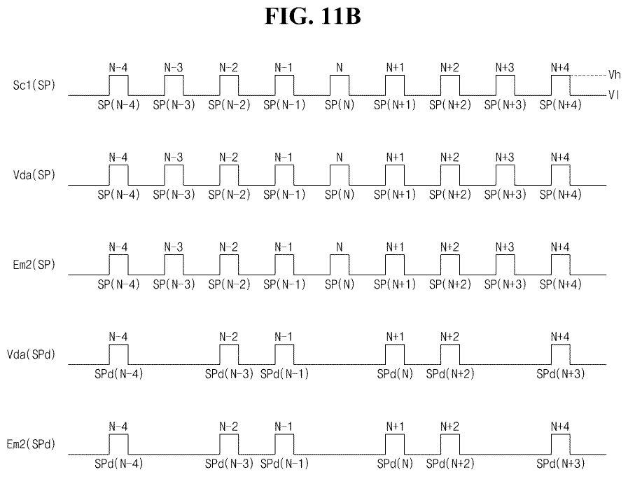

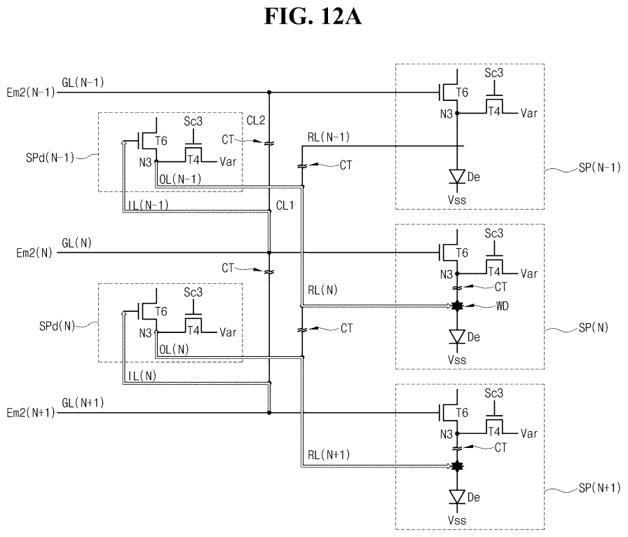

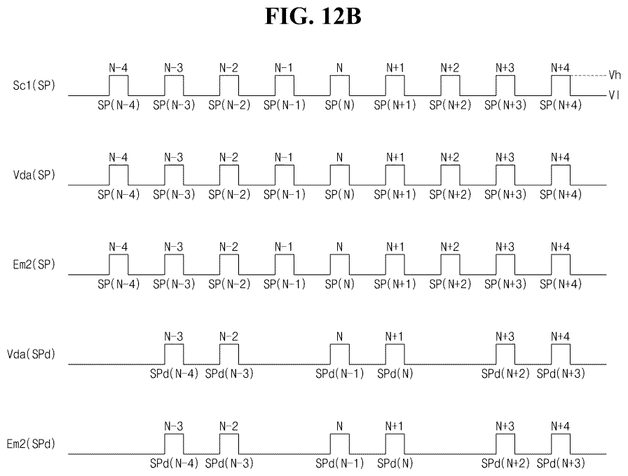

FIG. 10A is a view showing a first connection state of a dummy subpixel and an abnormal subpixel of a display device according to a second implementation of the present disclosure, and FIG. 10B is a view showing data signals and emission2 signals of a second connection state of a dummy subpixel and an abnormal subpixel of a display device according to a second implementation of the present disclosure. FIG. 11A is a view showing a second connection state of a dummy subpixel and an abnormal subpixel of a display device according to a second implementation of the present disclosure, and FIG. 11B is a view showing data signals and emission2 signals of a second connection state of a dummy subpixel and an abnormal subpixel of a display device according to a second implementation of the present disclosure. FIG. 12A is a view showing a third connection state of a dummy subpixel and an abnormal subpixel of a display device according to a second implementation of the present disclosure, and FIG. 12B is a view showing data signals and emission2 signals of a third connection state of a dummy subpixel and an abnormal subpixel of a display device according to a second implementation of the present disclosure.

In FIG. 10A, for a first connection state where the first to sixth transistors T1 to T6, the storage capacitor Cs and the auxiliary capacitor Ca of the (N−1)th and (N)th subpixels SP(N−1) and SP(N) of the (N−1)th and (N)th horizontal pixel lines abnormally operate, a connection of the third node N3 and the light emitting diode De of the (N−1)th subpixel SP(N−1) is cut, and a connection of the third node N3 and the light emitting diode De of the (N)th subpixel SP(N) is cut. Further, the light emitting diode De of the (N−1)th subpixel SP(N−1) and the (N−1)th repair line RL(N−1) are connected to each other, and the light emitting diode De of the (N)th subpixel SP(N) and the (N)th repair line RL(N) are connected to each other.

For example, a connecting line connecting the third node N3 and the anode of the light emitting diode De can be cut (CT) in the (N−1)th subpixel SP(N−1), and a connecting line connecting the third node N3 and the anode of the light emitting diode De can be cut (CT) in the (N)th subpixel SP(N). Further, the connecting line of the anode of the light emitting diode De of the (N−1)th subpixel SP(N−1) and the (N−1)th repair line RL(N−1) can be connected (welded) (WD) to each other, and the connecting line of the anode of the light emitting diode De of the (N)th subpixel SP(N) and the (N)th repair line RL(N) can be connected (welded) (WD) to each other.

The (N−1)th and (N)th repair lines RL(N−1) and RL(N) and the connecting lines of the anodes of the light emitting diodes De of the (N−1)th and (N)th subpixels SP(N−1) and SP(N) can overlap each other with an insulating layer interposed therebetween, and the insulating layer can be broken through a welding process (WD) to electrically connect the (N−1)th and (N)th repair lines RL(N−1) and RL(N) and the connecting lines of the anodes of the light emitting diodes De of the (N−1)th and (N)th subpixels SP(N−1) and SP(N).

In addition, a connection of the (N−1)th output line OL(N−1) of the (N−1)th dummy subpixel SPd(N−1) and the (N)th repair line RL(N) is cut, and a connection of the (N)th output line OL(N) of the (N)th dummy subpixel SPd(N) and the (N+1)th repair line RL(N+1) is cut.

For example, a first connecting line CL1 connecting the (N−1)th output line OL(N−1) of the (N−1)th dummy subpixel SPd(N−1) and the (N)th repair line RL(N) can be cut (CT), and a first connecting line CL1 connecting the (N)th output line OL(N) of the (N)th dummy subpixel SPd(N) and the (N+1)th repair line RL(N+1) can be cut (CT).

Further, a connection of the (N−1)th input line IL(N−1) of the (N−1)th dummy subpixel SPd(N−1) and the (N)th gate line GL(N) is cut, and a connection of the (N)th input line IL(N) of the (N)th dummy subpixel SPd(N) and the (N+1)th gate line GL(N+1) is cut.

For example, a second connecting line CL2 connecting the (N−1)th input line IL(N−1) of the (N−1)th dummy subpixel SPd(N−1) and the (N)th gate line GL(N) can be cut (CT), and a second connecting line CL2 connecting the (N)th input line IL(N) of the (N)th dummy subpixel SPd(N) and the (N+1)th gate line GL(N+1) can be cut (CT).

As a result, in the first connection state, the gate electrode of the sixth transistor T6 of the (N−1)th dummy subpixel SPd(N−1) is connected to the (N−1)th gate line GL(N−1) to receive the (N−1)th emission2 signal Em2(N−1), and the gate electrode of the sixth transistor T6 of the (N)th dummy subpixel SPd(N) is connected to the (N)th gate line GL(N) to receive the (N)th emission2 signal Em2(N). The third node N3 of the (N−1)th dummy subpixel SPd(N−1) is connected to and supplies the diode voltage to the anode of the light emitting diode De of the (N−1)th subpixel SP(N−1), and the third node N3 of the (N)th dummy subpixel SPd(N) is connected to and supplies the diode voltage to the anode of the light emitting diode De of the (N)th subpixel SP(N). Accordingly, the light emitting diodes De of the (N−1)th and (N)th subpixels SP(N−1) and SP(N) emit a light of a normal luminance.

The data signals Vda and the emission2 signals Em2 corresponding to the (N−1)th and (N)th horizontal pixel lines are supplied to the (N−1)th and (N)th dummy subpixels SPd(N−1) and SPd(N), respectively.

In FIG. 10B, for the first connection state, during a period where a logic high voltage Vh of the scan1 signal Sc1 is applied to the gate electrodes of the second transistors T2 of (N−4)th, (N−3)th, (N−2)th, (N−1)th, (N)th, (N+1)th, (N+2)th, (N+3)th and (N+4)th subpixels SP(N−4), SP(N−3), SP(N−2), SP(N−1), SP(N), SP(N+1), SP(N+2), SP(N+3) and SP(N+4) of (N−4)th, (N−3)th, (N−2)th, (N−1)th, (N)th, (N+1)th, (N+2)th, (N+3)th and (N+4)th horizontal pixel lines, (N−4)th, (N−3)th, (N−2)th, (N−1)th, (N)th, (N+1)th, (N+2)th, (N+3)th and (N+4)th data signals Vda(N−4), Vda(N−3), Vda(N−2), Vda(N−1), Vda(N), Vda(N+1), Vda(N+2), Vda(N+3) and Vda(N+4) are applied to the drain electrodes of the second transistors T2 of the (N−4)th, (N−3)th, (N−2)th, (N−1)th, (N)th, (N+1)th, (N+2)th, (N+3)th and (N+4)th subpixels SP(N−4), SP(N−3), SP(N−2), SP(N−1), SP(N), SP(N+1), SP(N+2), SP(N+3) and SP(N+4), respectively.

In response to a period where a logic high voltage Vh of the scan1 signal Sc1 is applied to the gate electrodes of the second transistors T2 of (N−4)th, (N−3)th, (N−2)th, (N−1)th, (N)th, (N+1)th, (N+2)th, (N+3)th and (N+4)th subpixels SP(N−4), SP(N−3), SP(N−2), SP(N−1), SP(N), SP(N+1), SP(N+2), SP(N+3) and SP(N+4), a logic high voltage Vh of the emission2 signal Em2 is applied to the gate electrodes of the sixth transistors T6 of the (N−4)th, (N−3)th, (N−2)th, (N−1)th, (N)th, (N+2)th, (N+3)th and (N+4)th subpixels SP(N−4), SP(N−3), SP(N−2), SP(N−1), SP(N), SP(N+1), SP(N+2), SP(N+3) and SP(N+4), respectively.

During a period where a logic high voltage Vh of the scan1 signal Sc1 is applied to the gate electrodes of the second transistors T2 of (N−4)th, (N−3)th, (N−1)th, (N)th, (N+2)th and (N+3)th subpixels SP(N−4), SP(N−3), SP(N−1), SP(N), SP(N+2) and SP(N+3), a logic high voltage Vh of the scan1 signal Sc1 is applied to the gate electrodes of the second transistors T2 of the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3), respectively, and the (N−4)th, (N−3)th, (N−1)th, (N)th, (N+2)th and (N+3)th data signals Vda(N−4), Vda(N−3), Vda(N−1), Vda(N), Vda(N+2) and Vda(N+3) are applied to the drain electrodes of the second transistors T2 of the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3), respectively.

In response to a period where a logic high voltage Vh of the scan1 signal Sc1 is applied to the gate electrodes of the second transistors T2 of (N−4)th, (N−3)th, (N−1)th, (N)th, (N+2)th and (N+3)th subpixels SP(N−4), SP(N−3), SP(N−1), SP(N), SP(N+2) and SP(N+3), a logic high voltage Vh of the emission2 signal Em2 is applied to the gate electrodes of the sixth transistors T6 of the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3), respectively.

In the first connection state, the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3) generate the diode voltages using the (N−4)th, (N−3)th, (N−1)th, (N)th, (N+2)th and (N+3)th data signals Vda(N−4), Vda(N−3), Vda(N−1), Vda(N), Vda(N+2) and Vda(N+3), respectively, according to the (N−4)th, (N−3)th, (N−1)th, (N)th, (N+2)th and (N+3)th emission2 signals Em2(N−4), Em2(N−3), Em2(N−1), Em2(N), Em2(N+2) and Em2(N+3), and supply the diode voltages to the anodes of the light emitting diodes De of the (N−4)th, (N−3)th, (N−1)th, (N)th, (N+2)th and (N+3)th subpixels SP(N−4), SP(N−3), SP(N−1), SP(N), SP(N+2) and SP(N+3), respectively.

In FIG. 11A, for a second connection state where the first to sixth transistors T1 to T6, the storage capacitor Cs and the auxiliary capacitor Ca of the (N−1)th and (N+1)th subpixels SP(N−1) and SP(N+1) of the (N−1)th and (N+1)th horizontal pixel lines abnormally operate, a connection of the third node N3 and the light emitting diode De of the (N−1)th subpixel SP(N−1) is cut, and a connection of the third node N3 and the light emitting diode De of the (N+1)th subpixel SP(N+1) is cut. Further, the light emitting diode De of the (N−1)th subpixel SP(N−1) and the (N−1)th repair line RL(N−1) are connected to each other, and the light emitting diode De of the (N+1)th subpixel SP(N+1) and the (N+1)th repair line RL(N+1) are connected to each other.

For example, a connecting line connecting the third node N3 and the anode of the light emitting diode De can be cut (CT) in the (N−1)th subpixel SP(N−1), and a connecting line connecting the third node N3 and the anode of the light emitting diode De can be cut (CT) in the (N+1)th subpixel SP(N+1). Further, the connecting line of the anode of the light emitting diode De of the (N−1)th subpixel SP(N−1) and the (N−1)th repair line RL(N−1) can be connected (welded) (WD) to each other, and the connecting line of the anode of the light emitting diode De of the (N+1)th subpixel SP(N+1) and the (N+1)th repair line RL(N+1) can be connected (welded) (WD) to each other.

The (N−1)th and (N+1)th repair lines RL(N−1) and RL(N+1) and the connecting lines of the anodes of the light emitting diodes De of the (N−1)th and (N+1)th subpixels SP(N−1) and SP(N+1) can overlap each other with an insulating layer interposed therebetween, and the insulating layer can be broken through a welding process (WD) to electrically connect the (N−1)th and (N+1)th repair lines RL(N−1) and RL(N+1) and the connecting lines of the anodes of the light emitting diodes De of the (N−1)th and (N+1)th subpixels SP(N−1) and SP(N+1).

In addition, a connection of the (N−1)th output line OL(N−1) of the (N−1)th dummy subpixel SPd(N−1) and the (N)th repair line RL(N) is cut, and a connection of the (N)th output line OL(N) of the (N)th dummy subpixel SPd(N) and the (N)th repair line RL(N) is cut.

For example, a first connecting line CL1 connecting the (N−1)th output line OL(N−1) of the (N−1)th dummy subpixel SPd(N−1) and the (N)th repair line RL(N) can be cut (CT), and a first connecting line CL1 connecting the (N)th output line OL(N) of the (N)th dummy subpixel SPd(N) and the (N)th repair line RL(N) can be cut (CT).

Further, a connection of the (N−1)th input line IL(N−1) of the (N−1)th dummy subpixel SPd(N−1) and the (N)th gate line GL(N) is cut, and a connection of the (N)th input line IL(N) of the (N)th dummy subpixel SPd(N) and the (N)th gate line GL(N) is cut.

For example, a second connecting line CL2 connecting the (N−1)th input line IL(N−1) of the (N−1)th dummy subpixel SPd(N−1) and the (N)th gate line GL(N) can be cut (CT), and a second connecting line CL2 connecting the (N)th input line IL(N) of the (N)th dummy subpixel SPd(N) and the (N)th gate line GL(N) can be cut (CT).

As a result, in the second connection state, the gate electrode of the sixth transistor T6 of the (N−1)th dummy subpixel SPd(N−1) is connected to the (N−1)th gate line GL(N−1) to receive the (N−1)th emission2 signal Em2(N−1), and the gate electrode of the sixth transistor T6 of the (N)th dummy subpixel SPd(N) is connected to the (N+1)th gate line GL(N+1) to receive the (N+1)th emission2 signal Em2(N+1). The third node N3 of the (N−1)th dummy subpixel SPd(N−1) is connected to and supplies the diode voltage to the anode of the light emitting diode De of the (N−1)th subpixel SP(N−1), and the third node N3 of the (N)th dummy subpixel SPd(N) is connected to and supplies the diode voltage to the anode of the light emitting diode De of the (N+1)th subpixel SP(N+1). Accordingly, the light emitting diodes De of the (N−1)th and (N+1)th subpixels SP(N−1) and SP(N+1) emit a light of a normal luminance.

The data signals Vda and the emission2 signals Em2 corresponding to the (N−1)th and (N+1)th horizontal pixel lines are supplied to the (N−1)th and (N)th dummy subpixels SPd(N−1) and SPd(N), respectively.

In FIG. 11B, for the second connection state, during a period where a logic high voltage Vh of the scan1 signal Sc1 is applied to the gate electrodes of the second transistors T2 of (N−4)th, (N−3)th, (N−2)th, (N−1)th, (N)th, (N+1)th, (N+2)th, (N+3)th and (N+4)th subpixels SP(N−4), SP(N−3), SP(N−2), SP(N−1), SP(N), SP(N+1), SP(N+2), SP(N+3) and SP(N+4) of (N−4)th, (N−3)th, (N−2)th, (N−1)th, (N)th, (N+1)th, (N+2)th, (N+3)th and (N+4)th horizontal pixel lines, (N−4)th, (N−3)th, (N−2)th, (N−1)th, (N)th, (N+1)th, (N+2)th, (N+3)th and (N+4)th data signals Vda(N−4), Vda(N−3), Vda(N−2), Vda(N−1), Vda(N), Vda(N+1), Vda(N+2), Vda(N+3) and Vda(N+4) are applied to the drain electrodes of the second transistors T2 of the (N−4)th, (N−3)th, (N−2)th, (N−1)th, (N)th, (N+1)th, (N+2)th, (N+3)th and (N+4)th subpixels SP(N−4), SP(N−3), SP(N−2), SP(N−1), SP(N), SP(N+1), SP(N+2), SP(N+3) and SP(N+4), respectively.

In response to a period where a logic high voltage Vh of the scan1 signal Sc1 is applied to the gate electrodes of the second transistors T2 of (N−4)th, (N−3)th, (N−2)th, (N−1)th, (N)th, (N+1)th, (N+2)th, (N+3)th and (N+4)th subpixels SP(N−4), SP(N−3), SP(N−2), SP(N−1), SP(N), SP(N+1), SP(N+2), SP(N+3) and SP(N+4), a logic high voltage Vh of the emission2 signal Em2 is applied to the gate electrodes of the sixth transistors T6 of the (N−4)th, (N−3)th, (N−2)th, (N−1)th, (N)th, (N+1)th, (N+2)th, (N+3)th and (N+4)th subpixels SP(N−4), SP(N−3), SP(N−2), SP(N−1), SP(N), SP(N+1), SP(N+2), SP(N+3) and SP(N+4), respectively.

During a period where a logic high voltage Vh of the scan1 signal Sc1 is applied to the gate electrodes of the second transistors T2 of (N−4)th, (N−2)th, (N−1)th, (N+1)th, (N+2)th and (N+4)th subpixels SP(N−4), SP(N−2), SP(N−1), SP(N+1), SP(N+2) and SP(N+4), a logic high voltage Vh of the scan1 signal Sc1 is applied to the gate electrodes of the second transistors T2 of the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3), respectively, and the (N−4)th, (N−2)th, (N−1)th, (N+1)th, (N+2)th and (N+4)th data signals Vda(N−4), Vda(N−2), Vda(N−1), Vda(N+1), Vda(N+2) and Vda(N+4) are applied to the drain electrodes of the second transistors T2 of the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3), respectively.

In response to a period where a logic high voltage Vh of the scan1 signal Sc1 is applied to the gate electrodes of the second transistors T2 of (N−4)th, (N−2)th, (N−1)th, (N+1)th, (N+2)th and (N+4)th subpixels SP(N−4), SP(N−2), SP(N−1), SP(N+1), SP(N+2) and SP(N+4), a logic high voltage Vh of the emission2 signal Em2 is applied to the gate electrodes of the sixth transistors T6 of the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3), respectively.

In the second connection state, the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3) generate the diode voltages using the (N−4)th, (N−2)th, (N−1)th, (N+1)th, (N+2)th and (N+4)th data signals Vda(N−4), Vda(N−2), Vda(N−1), Vda(N+1), Vda(N+2) and Vda(N+4), respectively, according to the (N−4)th, (N−2)th, (N−1)th, (N+1)th, (N+2)th and (N+4)th emission2 signals Em2(N−4), Em2(N−2), Em2(N−1), Em2(N+1), Em2(N+2) and Em2(N+4), and supply the diode voltages to the anodes of the light emitting diodes De of the (N−4)th, (N−2)th, (N−1)th, (N+1)th, (N+2)th and (N+4)th subpixels SP(N−4), SP(N−2), SP(N−1), SP(N+1), SP(N+2) and SP(N+4), respectively.

In FIG. 12A, for a third connection state where the first to sixth transistors T1 to T6, the storage capacitor Cs and the auxiliary capacitor Ca of the (N)th and (N+1)th subpixels SP(N) and SP(N+1) of the (N)th and (N+1)th horizontal pixel lines abnormally operate, a connection of the third node N3 and the light emitting diode De of the (N)th subpixel SP(N) is cut, and a connection of the third node N3 and the light emitting diode De of the (N+1)th subpixel SP(N+1) is cut. Further, the light emitting diode De of the (N)th subpixel SP(N) and the (N)th repair line RL(N) are connected to each other, and the light emitting diode De of the (N+1)th subpixel SP(N+1) and the (N+1)th repair line RL(N+1) are connected to each other.

For example, a connecting line connecting the third node N3 and the anode of the light emitting diode De can be cut (CT) in the (N)th subpixel SP(N), and a connecting line connecting the third node N3 and the anode of the light emitting diode De can be cut (CT) in the (N+1)th subpixel SP(N+1). Further, the connecting line of the anode of the light emitting diode De of the (N)th subpixel SP(N) and the (N)th repair line RL(N) can be connected (welded) (WD) to each other, and the connecting line of the anode of the light emitting diode De of the (N+1)th subpixel SP(N+1) and the (N+1)th repair line RL(N+1) can be connected (welded) (WD) to each other.

The (N)th and (N+1)th repair lines RL(N) and RL(N+1) and the connecting lines of the anodes of the light emitting diodes De of the (N)th and (N+1)th subpixels SP(N) and SP(N+1) can overlap each other with an insulating layer interposed therebetween, and the insulating layer can be broken through a welding process (WD) to electrically connect the (N)th and (N+1)th repair lines RL(N) and RL(N+1) and the connecting lines of the anodes of the light emitting diodes De of the (N)th and (N+1)th subpixels SP(N) and SP(N+1).

In addition, a connection of the (N−1)th output line OL(N−1) of the (N−1)th dummy subpixel SPd(N−1) and the (N−1)th repair line RL(N−1) is cut, and a connection of the (N)th output line OL(N) of the (N)th dummy subpixel SPd(N) and the (N)th repair line RL(N) is cut.

For example, a first connecting line CL1 connecting the (N−1)th output line OL(N−1) of the (N−1)th dummy subpixel SPd(N−1) and the (N−1)th repair line RL(N−1) can be cut (CT), and a first connecting line CL1 connecting the (N)th output line OL(N) of the (N)th dummy subpixel SPd(N) and the (N)th repair line RL(N) can be cut (CT).

Further, a connection of the (N−1)th input line IL(N−1) of the (N−1)th dummy subpixel SPd(N−1) and the (N−1)th gate line GL(N−1) is cut, and a connection of the (N)th input line IL(N) of the (N)th dummy subpixel SPd(N) and the (N)th gate line GL(N) is cut.

For example, a second connecting line CL2 connecting the (N−1)th input line IL(N−1) of the (N−1)th dummy subpixel SPd(N−1) and the (N−1)th gate line GL(N−1) can be cut (CT), and a second connecting line CL2 connecting the (N)th input line IL(N) of the (N)th dummy subpixel SPd(N) and the (N)th gate line GL(N) can be cut (CT).

As a result, in the third connection state, the gate electrode of the sixth transistor T6 of the (N−1)th dummy subpixel SPd(N−1) is connected to the (N)th gate line GL(N) to receive the (N)th emission2 signal Em2(N), and the gate electrode of the sixth transistor T6 of the (N)th dummy subpixel SPd(N) is connected to the (N+1)th gate line GL(N+1) to receive the (N+1)th emission2 signal Em2(N+1). The third node N3 of the (N−1)th dummy subpixel SPd(N−1) is connected to and supplies the diode voltage to the anode of the light emitting diode De of the (N)th subpixel SP(N), and the third node N3 of the (N)th dummy subpixel SPd(N) is connected to and supplies the diode voltage to the anode of the light emitting diode De of the (N+1)th subpixel SP(N+1). Accordingly, the light emitting diodes De of the (N)th and (N+1)th subpixels SP(N) and SP(N+1) emit a light of a normal luminance.

The data signals Vda and the emission2 signals Em2 corresponding to the (N)th and (N+1)th horizontal pixel lines are supplied to the (N−1)th and (N)th dummy subpixels SPd(N−1) and SPd(N), respectively.

In FIG. 12B, for the third connection state, during a period where a logic high voltage Vh of the scan1 signal Sc1 is applied to the gate electrodes of the second transistors T2 of (N−4)th, (N−3)th, (N−2)th, (N−1)th, (N)th, (N+1)th, (N+2)th, (N+3)th and (N+4)th subpixels SP(N−4), SP(N−3), SP(N−2), SP(N−1), SP(N), SP(N+1), SP(N+2), SP(N+3) and SP(N+4) of (N−4)th, (N−3)th, (N−2)th, (N−1)th, (N)th, (N+1)th, (N+2)th, (N+3)th and (N+4)th horizontal pixel lines, (N−4)th, (N−3)th, (N−2)th, (N−1)th, (N)th, (N+1)th, (N+2)th, (N+3)th and (N+4)th data signals Vda(N−4), Vda(N−3), Vda(N−2), Vda(N−1), Vda(N), Vda(N+1), Vda(N+2), Vda(N+3) and Vda(N+4) are applied to the drain electrodes of the second transistors T2 of the (N−4)th, (N−3)th, (N−2)th, (N−1)th, (N)th, (N+1)th, (N+2)th, (N+3)th and (N+4)th subpixels SP(N−4), SP(N−3), SP(N−2), SP(N−1), SP(N), SP(N+1), SP(N+2), SP(N+3) and SP(N+4), respectively.

In response to a period where a logic high voltage Vh of the scan1 signal Sc1 is applied to the gate electrodes of the second transistors T2 of (N−4)th, (N−3)th, (N−2)th, (N−1)th, (N)th, (N+1)th, (N+2)th, (N+3)th and (N+4)th subpixels SP(N−4), SP(N−3), SP(N−2), SP(N−1), SP(N), SP(N+1), SP(N+2), SP(N+3) and SP(N+4), a logic high voltage Vh of the emission2 signal Em2 is applied to the gate electrodes of the sixth transistors T6 of the (N−4)th, (N−3)th, (N−2)th, (N−1)th, (N)th, (N+1)th, (N+2)th, (N+3)th and (N+4)th subpixels SP(N−4), SP(N−3), SP(N−2), SP(N−1), SP(N), SP(N+1), SP(N+2), SP(N+3) and SP(N+4), respectively.

During a period where a logic high voltage Vh of the scan1 signal Sc1 is applied to the gate electrodes of the second transistors T2 of (N−3)th, (N−2)th, (N)th, (N+1)th, (N+3)th and (N+4)th subpixels SP(N−3), SP(N−2), SP(N), SP(N+1), SP(N+3) and SP(N+4), a logic high voltage Vh of the scan1 signal Sc1 is applied to the gate electrodes of the second transistors T2 of the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3), respectively, and the (N−3)th, (N−2)th, (N)th, (N+1)th, (N+3)th and (N+4)th data signals Vda(N−3), Vda(N−2), Vda(N), Vda(N+1), Vda(N+3) and Vda(N+4) are applied to the drain electrodes of the second transistors T2 of the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3), respectively.

In response to a period where a logic high voltage Vh of the scan1 signal Sc1 is applied to the gate electrodes of the second transistors T2 of (N−3)th, (N−2)th, (N)th, (N+1)th, (N+3)th and (N+4)th subpixels SP(N−3), SP(N−2), SP(N), SP(N+1), SP(N+3) and SP(N+4), a logic high voltage Vh of the emission2 signal Em2 is applied to the gate electrodes of the sixth transistors T6 of the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3), respectively.

In the third connection state, the (N−4)th, (N−3)th, (N−1)th, (N)th, (N+2)th and (N+3)th dummy subpixels SPd(N−4), SPd(N−3), SPd(N−1), SPd(N), SPd(N+2) and SPd(N+3) generate the diode voltages using the (N−3)th, (N−2)th, (N)th, (N+1)th, (N+3)th and (N+4)th data signals Vda(N−3), Vda(N−2), Vda(N), Vda(N+1), Vda(N+3) and Vda(N+4), respectively, according to the (N−3)th, (N−2)th, (N)th, (N+1)th, (N+3)th and (N+4)th emission2 signals Em2(N−3), Em2(N−2), Em2(N), Em2(N+1), Em2(N+3) and Em2(N+4) and supply the diode voltages to the anodes of the light emitting diodes De of the (N−3)th, (N−2)th, (N)th, (N+1)th, (N+3)th and (N+4)th subpixels SP(N−3), SP(N−2), SP(N), SP(N+1), SP(N+3) and SP(N+4), respectively.

When all of the (N−1)th, (N)th and (N+1)th subpixels SP(N−1), SP(N) and SP(N+1) normally operate, the second connecting line CL2 connecting the (N−1)th and (N)th gate lines GL(N−1) and GL(N) and the second connecting line CL2 connecting the (N)th and (N+1)th gate lines GL(N) and GL(N+1) are cut (CT).

In the display device according to a second implementation of the present disclosure, the dummy subpixels SPd are formed to have a number smaller than a number of the horizontal pixel lines to increase an area of the auxiliary capacitor Ca of each dummy subpixel. As a result, the current of the first transistor T1 increases, and deterioration such as a bright dot or a dark dot is prevented by compensating the voltage drop through the repair line RL. Further, a display quality is improved and a low power consumption driving is obtained.

In addition, since an area and a number of the dummy subpixel SPd is reduced, an area of a bezel is reduced.

Further, the emission2 signal corresponding to the horizontal pixel line connected to the dummy subpixel SPd is supplied the dummy subpixel SPd, and the light emitting diode of the subpixel emits a light at an exact timing. As a result, delay of emission is prevented, and a display quality of an image is improved.

Although two dummy subpixels are exemplarily disposed for three horizontal pixel lines in the first and second implementations, a plurality of dummy subpixel having a number smaller than a number of a plurality of horizontal pixel lines can be disposed for the plurality of horizontal pixel lines in another implementation. For example, one dummy subpixel can be disposed for two horizontal pixel lines or three dummy subpixels can be disposed for four horizontal pixel lines in another implementation.

It will be apparent to those skilled in the art that various modifications and variation can be made in the present disclosure without departing from the scope of the disclosure. Thus, it is intended that the present disclosure cover the modifications and variations of this disclosure provided they come within the scope of the appended claims and their equivalents.

What is claimed is:

1. A display device, comprising:
a timing controlling unit configured to generate image data, a data control signal and a gate control signal;
a data driving unit configured to generate a data signal using the image data and the data control signal;
a gate driving unit configured to generate a gate signal using the gate control signal; and
a display panel configured to display an image using the gate signal and the data signal, the display panel comprising a display area and a non-display area at a periphery of the display area, wherein:
the display area comprises a plurality of subpixels arranged as a plurality of horizontal pixel lines,
the non-display area comprises a plurality of dummy subpixels,
a plurality of repair lines extend to the plurality of horizontal pixel lines, respectively, and
each of the plurality of dummy subpixels is connected to at least two of the plurality of repair lines extending to at least two of the plurality of horizontal pixel lines.

2. The display device of claim 1, wherein a number of the plurality of dummy subpixels is smaller than a number of the plurality of horizontal pixel lines.

3. The display device of claim 1, wherein each of the plurality of subpixels includes a respective plurality of transistors, storage capacitor, auxiliary capacitor and light emitting diode, and
wherein each of the plurality of dummy subpixels includes a respective plurality of transistors, storage capacitor and auxiliary capacitor.

4. The display device of claim 3, wherein each of the plurality of repair lines overlaps an anode of the light emitting diode of one of the plurality of subpixels.

5. The display device of claim 4, wherein when at least one of the plurality of transistors, the storage capacitor and the auxiliary capacitor of the one of the plurality of subpixels abnormally operates,
a connection of the plurality of transistors and the light emitting diode in the one of the plurality of subpixels is cut, and
the anode of the light emitting diode of the one of the plurality of subpixels is connected to one of the plurality of repair lines overlapping the anode.

6. The display device of claim 3, wherein the output line of each of the plurality of dummy subpixels outputs a current having a size depending from a capacitance ratio between the storage capacitor and the auxiliary capacitor.

7. The display device of claim 3, wherein an area of the auxiliary capacitor in each of the plurality of dummy subpixels is greater than an area of the auxiliary capacitor in each of the plurality of subpixels.

8. The display device of claim 3, wherein two output lines of two of the plurality of dummy subpixels are commonly connected to three of the plurality of repair lines corresponding to three of the plurality of horizontal pixel lines.

9. The display device of claim 3, wherein three output lines of three of the plurality of dummy subpixels are commonly connected to four of the plurality of repair lines corresponding to four of the plurality of horizontal pixel lines.

10. The display device of claim 5, further comprising:
a plurality of gate lines extending to the plurality of horizontal pixel lines, respectively, to transmit the gate signal; and
an input line connected to a gate electrode of at least one of the plurality transistors of each of the plurality of dummy subpixels,
wherein when at least one of the plurality of transistors, the storage capacitor and the auxiliary capacitor of the one of the plurality of subpixels abnormally operates, one of the plurality of gate lines corresponding to the one of the plurality of subpixels is connected to the input line.

11. The display device of claim 3, wherein the plurality of horizontal pixel lines include (N−1)th, (N)th and (N+1)th horizontal pixel lines,
wherein the plurality of subpixels include an (N−1)th subpixel in the (N−1)th horizontal pixel line, an (N)th subpixel in the (N)th horizontal pixel line and an (N+1)th subpixel in the (N+1)th horizontal pixel line,
wherein the plurality of dummy subpixels include (N−1)th and (N)th dummy subpixels,
wherein the plurality of repair lines include (N−1)th, (N)th and (N+1)th repair lines overlapping the anodes of the light emitting diodes of the (N−1)th, (N)th and (N+1)th subpixels, respectively, and
wherein an (N−1)th output line of the (N−1)th dummy subpixel and an (N)th output line of the (N)th dummy subpixel are connected to a first connecting line connecting the (N−1)th, (N)th and (N+1)th repair lines.

12. The display device of claim 11, wherein when at least one of the plurality of transistors, the storage capacitor and the auxiliary capacitor of the (N−1)th subpixel abnormally operates and at least one of the plurality of transistors, the storage capacitor and the auxiliary capacitor of the (N)th subpixel abnormally operates,
a connection of the (N−1)th output line and the (N)th repair line is cut, and a connection of the (N)th output line and the (N+1)th repair line is cut.

13. The display device of claim 12, wherein data signals corresponding to the (N−1)th and (N)th subpixels are supplied to the (N−1)th and (N)th dummy subpixels, respectively.

14. The display device of claim 11, wherein when at least one of the plurality of transistors, the storage capacitor and the auxiliary capacitor of the (N−1)th subpixel abnormally operates and at least one of the plurality of transistors, the storage capacitor and the auxiliary capacitor of the (N+1)th subpixel abnormally operates,
a connection of the (N−1)th output line and the (N)th repair line is cut, and a connection of the (N)th output line and the (N)th repair line is cut.

15. The display device of claim 14, wherein data signals corresponding to the (N−1)th and (N+1)th subpixels are supplied to the (N−1)th and (N)th dummy subpixels, respectively.

16. The display device of claim 11, wherein when at least one of the plurality of transistors, the storage capacitor and the auxiliary capacitor of the (N)th subpixel abnormally operates and at least one of the plurality of transistors, the storage capacitor and the auxiliary capacitor of the (N+1)th subpixel abnormally operates,
a connection of the (N−1)th output line and the (N−1)th repair line is cut, and a connection of the (N)th output line and the (N)th repair line is cut.

17. The display device of claim 16, wherein data signals corresponding to the (N)th and (N+1)th subpixels are supplied to the (N−1)th and (N)th dummy subpixels, respectively.

18. The display device of claim 11, further comprising:
(N−1)th, (N)th and (N+1)th gate lines connected to the (N−1)th, (N)th and (N+1)th subpixels, respectively, and
(N−1)th and (N)th input lines connected to a gate electrode of at least one of the plurality of transistors of the (N−1)th dummy subpixel and a gate electrode of at least one of the plurality of transistors of the (N)th dummy subpixel, respectively,
wherein when at least one of the plurality of transistors, the storage capacitor and the auxiliary capacitor of the (N−1)th subpixel abnormally operates and at least one of the plurality of transistors, the storage capacitor and the auxiliary capacitor of the (N)th subpixels abnormally operates, the (N−1)th input line is connected to the (N−1)th gate line, and the (N)th input line is connected to the (N)th gate line,
wherein when at least one of the plurality of transistors, the storage capacitor and the auxiliary capacitor of the (N−1)th subpixel abnormally operates and at least one of the plurality of transistors, the storage capacitor and the auxiliary capacitor of the (N+1)th subpixel abnormally operates, the (N−1)th input line is connected to the (N−1)th gate line, and the (N)th input line is connected to the (N+1)th gate line, wherein when at least one of the plurality of transistors, the storage capacitor and the auxiliary capacitor of the (N)th subpixel abnormally operates and at least one of the plurality of transistors, the storage capacitor and the auxiliary capacitor of the (N+1)th subpixel abnormally operates, the (N−1)th input line is connected to the (N)th gate line, and the (N)th input line is connected to the (N+1)th gate line.

19. The display device of claim 3, wherein the respective plurality of transistors for each subpixel and for each dummy subpixel comprises:
a first transistor switched according to a voltage of a first node and connected to a second node;
a second transistor switched according to a scan1 signal and connected to the first node and the data signal;
a third transistor switched according to a scan2 signal and connected to the first node and a reference signal;
a fourth transistor switched according to a scan3 signal and connected to a third node and an anode reset signal;
a fifth transistor switched according to an emission1 signal and connected to the first transistor and a high level signal; and
a sixth transistor switched according to an emission2 signal and connected to the third node and the second node.

20. The display device of claim 19, wherein a gate electrode of the first transistor, a first capacitor electrode of the storage capacitor, a source electrode of the second transistor and a source electrode of the third transistor constitute the first node,
wherein a source electrode of the first transistor, a second capacitor electrode of the storage capacitor, a first capacitor electrode of the auxiliary capacitor and a drain electrode of the sixth transistor constitute the second node, and
wherein a source electrode of the fourth transistor and a source electrode of the sixth transistor constitute the third node.
